(19) United States
(12) Patent Application Publication
(10) Pub. No.: US 2025/0069255 A1
(43) Pub. Date: Feb. 27, 2025

(54) RAPID LOCALIZATION FOR VISION-AIDED POSITIONING

(71) Applicant: QUALCOMM Incorporated, San Diego, CA (US)

(72) Inventors: Yuxiang PENG, Sunnyvale, CA (US); Bala RAMASAMY, San Marcos, CA (US); Ning LUO, Cupertino, CA (US)

(21) Appl. No.: 18/453,705

(22) Filed: Aug. 22, 2023

(51) Int. Cl. G06T 7/73

(52) U.S. Cl. CPC G06T 7/73; G06T 2207/30244; H04W 64/00

(57) ABSTRACT

Aspects presented herein may enable a UE to improve (e.g., reduce) the convergence time for vision-aided positioning by enabling the UE to use images embedded with location information. In one aspect, a UE receives, from a reference device, a server, or a map, a list of visual features and a location for each visual feature in the list of visual features. The UE identifies at least one visual feature in an area via at least one camera, where the at least one visual feature is included in the list of visual features, where the area is within a threshold distance of the UE. The UE estimates a position of the UE based on the identified at least one visual feature in the area and the location corresponding to the at least one visual feature.

### TECHNICAL FIELD

The present disclosure relates generally to communication systems, and more particularly, to a wireless communication involving positioning.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

In some scenarios, when vision-aided/based positioning starts (or is triggered/activated), a certain amount of convergence time may also be specified for a precise positioning due to inertial measurement unit (IMU) bias calibration and feature tracking. Thus, aspects presented herein may improve (e.g., reduce) the convergence time for vision-aided/based positioning by enabling a positioning device to use images embedded with location information to remove (common) perception errors in the positioning device.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus receives, from a reference device, a server, or a map, a list of visual features and a location for each visual feature in the list of visual features. The apparatus identifies at least one visual feature in an area via at least one camera, where the at least one visual feature is included in the list of visual features, where the area is within a threshold distance of a user equipment (UE). The apparatus estimates a position of the UE based on the identified at least one visual feature in the area and the location corresponding to the at least one visual feature.

In an aspect of the disclosure, a method, a computer-readable medium, and an apparatus are provided. The apparatus estimates a six degrees of freedom (6DOF) of the reference device. The apparatus transmits a list of visual features and a location for each visual feature in the list of visual features, the 6DOF of the reference device, and a set of global navigation satellite system (GNSS) measurements.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements.

FIG. 5 is a diagram illustrating an example of global navigation satellite system (GNSS) positioning in accordance with various aspects of the present disclosure.

FIG. 6 is a diagram illustrating an example of a real time kinematics (RTK) positioning in accordance with various aspects of the present disclosure.

FIG. 7 is a diagram illustrating an example of camera-aided positioning in accordance with various aspects of the present disclosure.

FIG. 8 is a diagram illustrating an example of a navigation application in accordance with various aspects of the present disclosure.

FIG. 9 is a communication flow illustrating an example of cooperative vision-aided positioning based on common environmental feature(s) in accordance with various aspects of the present disclosure.

FIG. 10 is a diagram illustrating an example of cooperative vision-aided positioning based on artificial/virtual feature(s) in accordance with various aspects of the present disclosure.

FIG. 11 is a diagram illustrating an example of vision-aided positioning based on feature matching with map(s) in accordance with various aspects of the present disclosure.

FIG. 12 is a diagram illustrating an example of a UE time (dynamic) model enhancement using maps in accordance with various aspects of the present disclosure.

FIG. 13 is a diagram illustrating an example Kalman filter in accordance with various aspects of the present disclosure.

FIG. 14 is a flowchart of a method of wireless communication.

FIG. 15 is a flowchart of a method of wireless communication.

FIG. 16 is a diagram illustrating an example of a hardware implementation for an example apparatus and/or network entity.

FIG. 17 is a flowchart of a method of wireless communication.

FIG. 18 is a flowchart of a method of wireless communication.

FIG. 19 is a diagram illustrating an example of a hardware implementation for an example network entity.

### DETAILED DESCRIPTION

Aspects presented herein may improve (e.g., reduce) the convergence time for vision-aided positioning, such as vision-aided precise positioning (VAPP). Aspects presented herein may provide a rapid localization for vision-aided positioning by enabling images embedded with location information to be used for removing (common) perception errors in a positioning device (e.g., such as during a Global Navigation Satellite Systems (GNSS) outage). In one aspect of the present disclosure, the convergence time of vision-based positioning may be reduced based on using common visual feature(s) (e.g., cooperative VAPP using common visual feature), where a positioning device (e.g., a user equipment (UE), a camera, a vehicle, a positioning engine, etc.) may select a set of common environmental features nearby for a fast localization (e.g., for determining the position and/or the attitude). In some implementation, when such common feature(s) are not detected/available, the positioning device may also use artificial feature(s) that are created and customized. In another aspect of the present disclosure, the convergence time of vision-based positioning may be reduced based on map data assistance (e.g., high-definition (HD) map assistance), where a positioning device may perform feature matching with maps (e.g., HD maps) to obtain external precise location source, perform UE time (dynamic) model enhancement with maps, and/or perform radio frequency (RF)-based (GNSS) positioning error modelling based on maps, etc.

Aspects presented herein are directed to enhancements related to vision-aided precise positioning (VAPP). Aspects presented herein include the followings aspects/features: 1) Cooperative VAPP using common visual features—(a) select common environment features nearby for fast localization (altitude and position), and (b) create and customize artificial features when no common feature is detected; 2) HD map assistance VAPP—(a) Feature matching with HD maps to obtain external precise location source, and (b) UE Time (Dynamic) model enhancement with HD maps, and (c) RF-based (GNSS) positioning error modelling based on HD maps.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

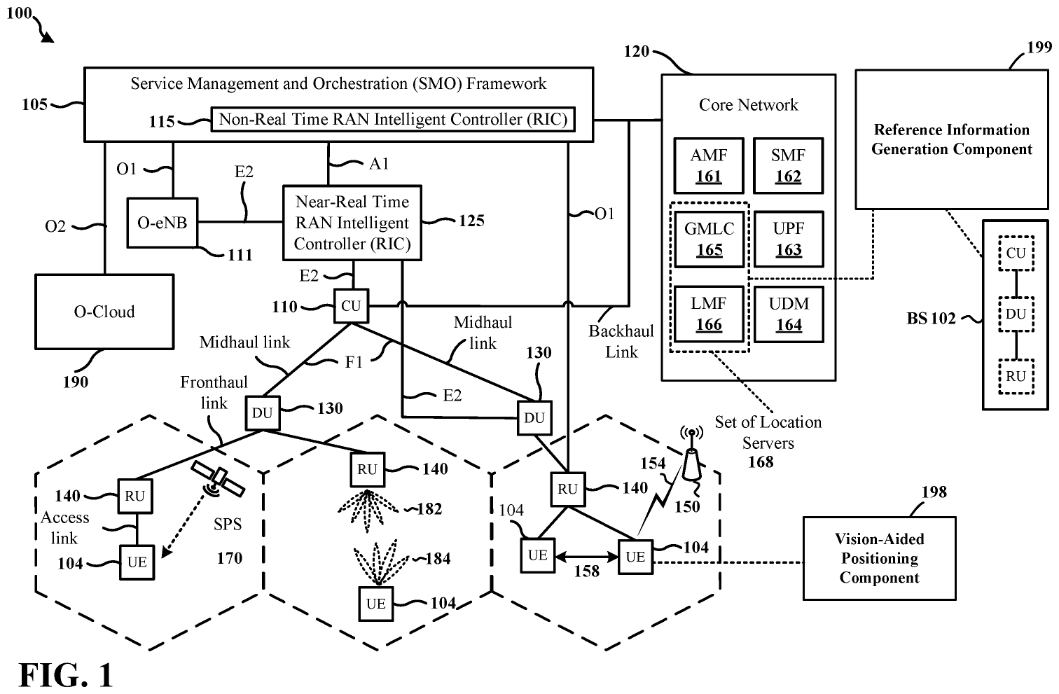

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHZ), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a vision-aided positioning component 198 that may be configured to receive, from a reference device, a server, or a map, a list of visual features and a location for each visual feature in the list of visual features; identify at least one visual feature in an area via at least one camera, where the at least one visual feature is included in the list of visual features, where the area is within a threshold distance of the UE; and estimate a position of the UE based on the identified at least one visual feature in the area and the location corresponding to the at least one visual feature. In certain aspects, a reference system/device (e.g., the reference system 904), the base station 102 or the one or more location servers 168 may have a reference information generation component 199 that may be configured to estimate a six degrees of freedom (6DOF) of the reference device; and transmit a list of visual features and a location for each visual feature in the list of visual features, the 6DOF of the reference device, and a set of global navigation satellite system (GNSS) measurements.

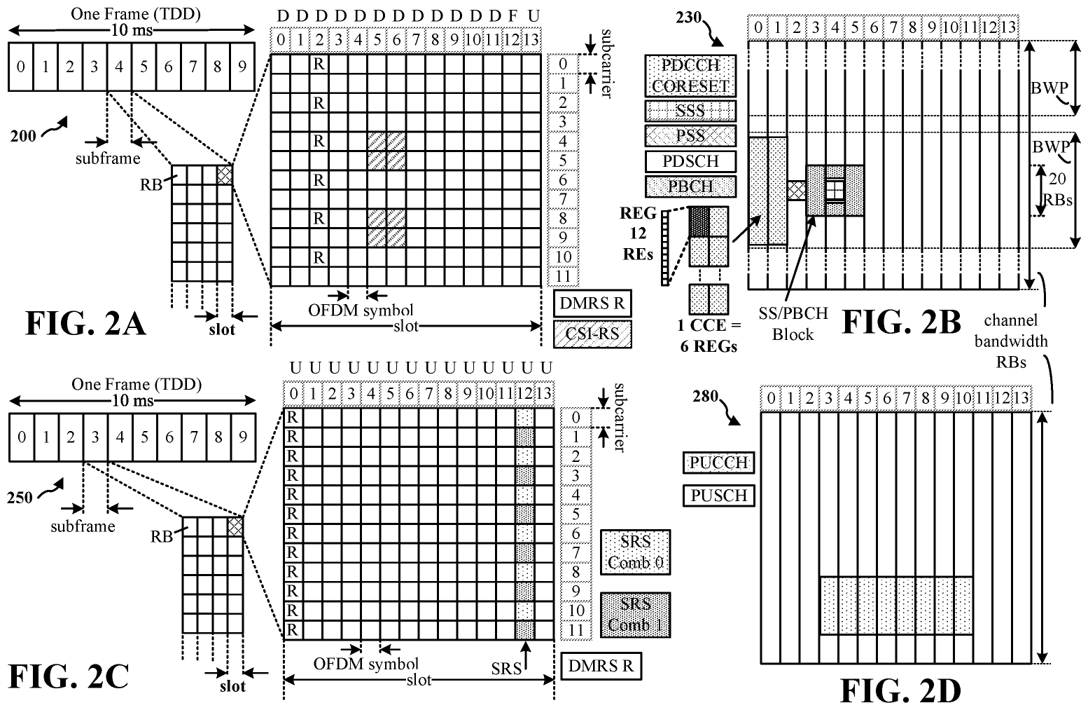

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | Cyclic |
|---|---|---|
| μ | Δf = 2^{μ} · 15[kHz] | prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 2^{μ} slots/subframe. The subcarrier spacing may be equal to 2^{μ}*15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

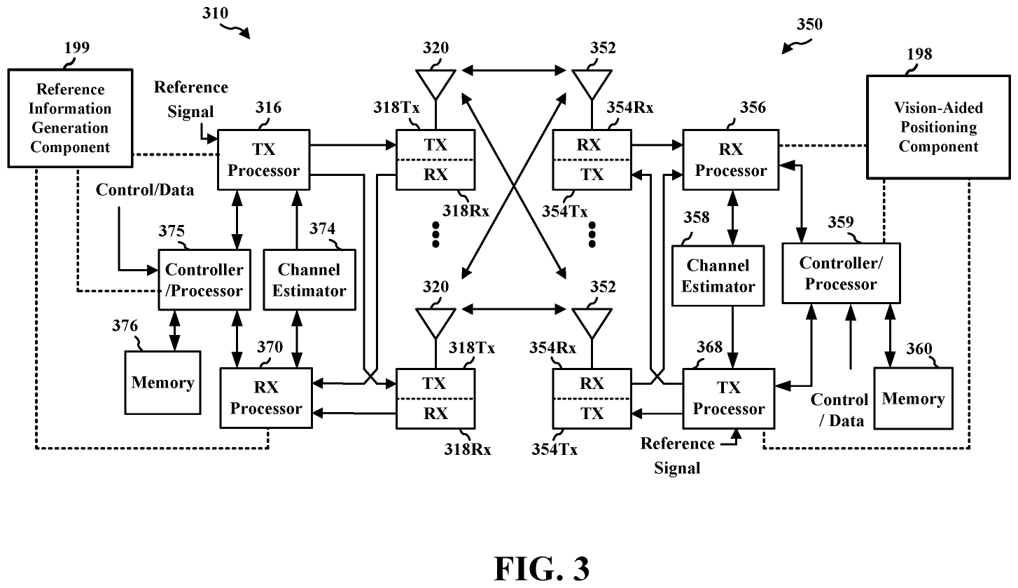

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BASK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the vision-aided positioning component 198 of FIG. 1.

At least one of the TX processor 316, the RX processor 370, and the controller/processor 375 may be configured to perform aspects in connection with the reference information generation component 199 of FIG. 1.

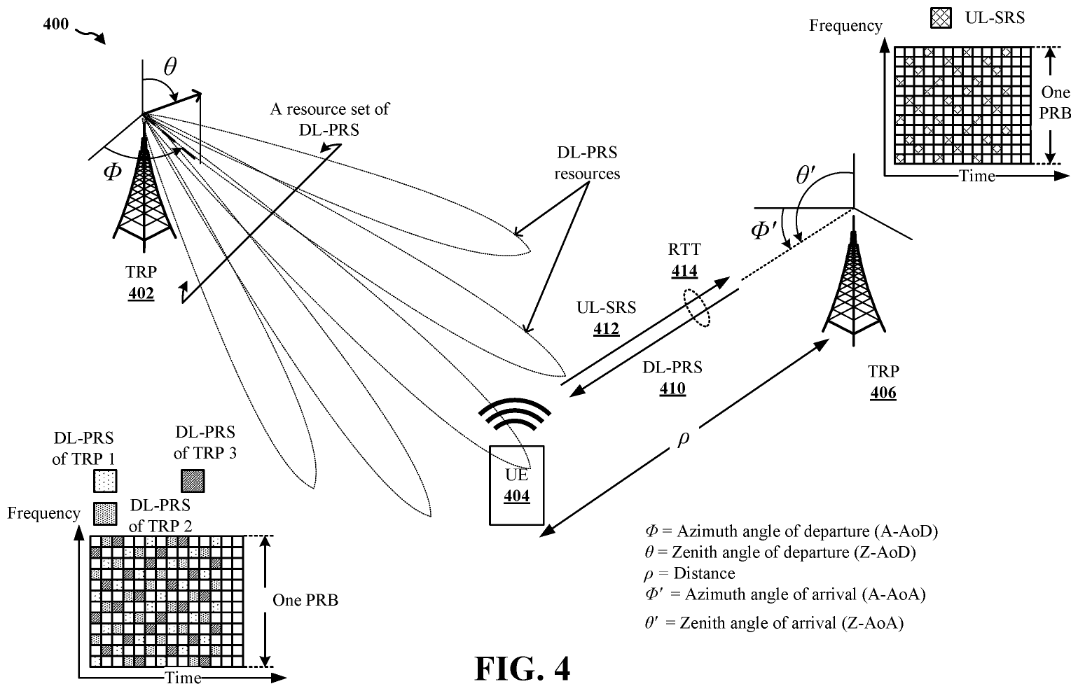

FIG. 4 is a diagram 400 illustrating an example of a UE positioning based on reference signal measurements (which may also be referred to as “network-based positioning”) in accordance with various aspects of the present disclosure. The UE 404 may transmit UL SRS 412 at time T_{SRS_TX} and receive DL positioning reference signals (PRS) (DL PRS) 410 at time T_{PRS_RX}. The TRP 406 may receive the UL SRS 412 at time T_{SRS_RX} and transmit the DL PRS 410 at time T_{PRS_TX}. The UE 404 may receive the DL PRS 410 before transmitting the UL SRS 412, or may transmit the UL SRS 412 before receiving the DL PRS 410. In both cases, a positioning server (e.g., location server(s) 168) or the UE 404 may determine the RTT 414 based on ∥T_{SRS_RX}−T_{PRS_TX}|−|T_{SRS_TX}−T_{PRS_RX}∥. Accordingly, multi-RTT positioning may make use of the UE Rx-Tx time difference measurements (i.e., |T_{SRS_TX}−T_{PRS_RX}|) and DL PRS reference signal received power (RSRP) (DL PRS-RSRP) of downlink signals received from multiple TRPs 402, 406 and measured by the UE 404, and the measured TRP Rx-Tx time difference measurements (i.e., |T_{SRS_RX}−T_{PRS_TX}|) and UL SRS-RSRP at multiple TRPs 402, 406 of uplink signals transmitted from UE 404. The UE 404 measures the UE Rx-Tx time difference measurements (and/or DL PRS-RSRP of the received signals) using assistance data received from the positioning server, and the TRPs 402, 406 measure the gNB Rx-Tx time difference measurements (and/or UL SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

PRSs may be defined for network-based positioning (e.g., NR positioning) to enable UEs to detect and measure more neighbor transmission and reception points (TRPs), where multiple configurations are supported to enable a variety of deployments (e.g., indoor, outdoor, sub-6, mmW, etc.). To support PRS beam operation, beam sweeping may also be configured for PRS. The UL positioning reference signal may be based on sounding reference signals (SRSs) with enhancements/adjustments for positioning purposes. In some examples, UL-PRS may be referred to as “SRS for positioning,” and a new Information Element (IE) may be configured for SRS for positioning in RRC signaling.

DL PRS-RSRP may be defined as the linear average over the power contributions (in [W]) of the resource elements of the antenna port(s) that carry DL PRS reference signals configured for RSRP measurements within the considered measurement frequency bandwidth. In some examples, for FR1, the reference point for the DL PRS-RSRP may be the antenna connector of the UE. For FR2, DL PRS-RSRP may be measured based on the combined signal from antenna elements corresponding to a given receiver branch. For FR1 and FR2, if receiver diversity is in use by the UE, the reported DL PRS-RSRP value may not be lower than the corresponding DL PRS-RSRP of any of the individual receiver branches. Similarly, UL SRS-RSRP may be defined as linear average of the power contributions (in [W]) of the resource elements carrying sounding reference signals (SRS). UL SRS-RSRP may be measured over the configured resource elements within the considered measurement frequency bandwidth in the configured measurement time occasions. In some examples, for FR1, the reference point for the UL SRS-RSRP may be the antenna connector of the base station (e.g., gNB). For FR2, UL SRS-RSRP may be measured based on the combined signal from antenna elements corresponding to a given receiver branch. For FR1 and FR2, if receiver diversity is in use by the base station, the reported UL SRS-RSRP value may not be lower than the corresponding UL SRS-RSRP of any of the individual receiver branches.

PRS-path RSRP (PRS-RSRPP) may be defined as the power of the linear average of the channel response at the i-th path delay of the resource elements that carry DL PRS signal configured for the measurement, where DL PRS-RSRPP for the 1st path delay is the power contribution corresponding to the first detected path in time. In some examples, PRS path Phase measurement may refer to the phase associated with an i-th path of the channel derived using a PRS resource.

DL-AoD positioning may make use of the measured DL PRS-RSRP of downlink signals received from multiple TRPs 402, 406 at the UE 404. The UE 404 measures the DL PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406.

DL-TDOA positioning may make use of the DL reference signal time difference (RSTD) (and/or DL PRS-RSRP) of downlink signals received from multiple TRPs 402, 406 at the UE 404. The UE 404 measures the DL RSTD (and/or DL PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and/or UL SRS-RSRP) at multiple TRPs 402, 406 of uplink signals transmitted from UE 404. The TRPs 402, 406 measure the UL-RTOA (and/or UL SRS-RSRP) of the received signals using assistance data received from the positioning server, and the resulting measurements are used along with other configuration information to estimate the location of the UE 404.

UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404. For purposes of the present disclosure, a positioning operation in which measurements are provided by a UE to a base station/positioning entity/server to be used in the computation of the UE's position may be described as “UE-assisted,” “UE-assisted positioning,” and/or “UE-assisted position calculation,” while a positioning operation in which a UE measures and computes its own position may be described as “UE-based,” “UE-based positioning,” and/or “UE-based position calculation.”

Additional positioning methods may be used for estimating the location of the UE 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

Note that the terms “positioning reference signal” and “PRS” generally refer to specific reference signals that are used for positioning in NR and LTE systems. However, as used herein, the terms “positioning reference signal” and “PRS” may also refer to any type of reference signal that can be used for positioning, such as but not limited to, PRS as defined in LTE and NR, TRS, PTRS, CRS, CSI-RS, DMRS, PSS. SSS. SSB, SRS, UL-PRS, etc. In addition, the terms “positioning reference signal” and “PRS” may refer to downlink or uplink positioning reference signals, unless otherwise indicated by the context. To further distinguish the type of PRS, a downlink positioning reference signal may be referred to as a “DL PRS,” and an uplink positioning reference signal (e.g., an SRS-for-positioning, PTRS) may be referred to as an “UL-PRS.” In addition, for signals that may be transmitted in both the uplink and downlink (e.g., DMRS, PTRS), the signals may be prepended with “UL” or “DL” to distinguish the direction. For example, “UL-DMRS” may be differentiated from “DL-DMRS.” In addition, the term “location” and “position” may be used interchangeably throughout the specification, which may refer to a particular geographical or a relative place.

A device (e.g., a UE) equipped with a global navigation satellite system (GNSS) receiver (which may include the Global Positioning System (GPS) receiver) may determine its location based on GNSS positioning. GNSS is a network of satellites broadcasting timing and orbital information used for navigation and positioning measurements. GNSS may include multiple groups of satellites, known as constellations, that broadcast signals (which may be referred to as GNSS signals) to control stations and users of the GNSS. Based on the broadcast signals, the users may be able to determine their locations (e.g., via trilateration process). For purposes of the present disclosure, a device (e.g., a UE) that is equipped with a GNSS receiver or is capable of receiving GNSS signals may be referred to as a GNSS device, and a device that is capable of transmitting GNSS signals, such as a satellite, may be referred to as a space vehicle (SV).

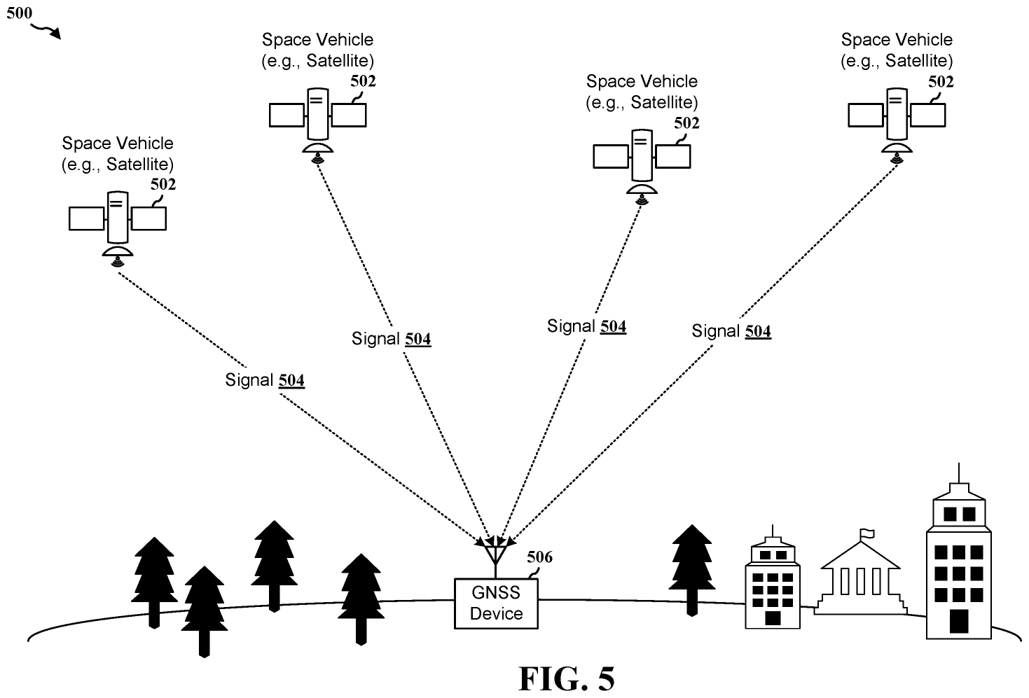

FIG. 5 is a diagram 500 illustrating an example of GNSS positioning in accordance with various aspects of the present disclosure. A GNSS device 506 may calculate its position and time based at least in part on data (e.g., GNSS signals 504) received from multiple space vehicles (SVs) 502, where each SV 502 may carry a record of its position and time and may transmit that data (e.g., the record) to the GNSS device 506. Each SV 502 may further include a clock that is synchronized with other clocks of SVs and with ground clock(s). If an SV 502 detects that there is a drift from the time maintained on the ground, the SV 502 may correct it. The GNSS device 506 may also include a clock, but the clock for the GNSS device 506 may be less stable and precise compared to the clocks for each SV 502.

As the speed of radio waves may be constant and independent of the satellite speed, a time delay between a time the SV 502 transmits a GNSS signal 504 and a time the GNSS device 506 receives the GNSS signal 504 may be proportional to the distance from the SV 502 to the GNSS device 506. In some examples, a minimum of four SVs may be used by the GNSS device 506 to compute/calculate one or more unknown quantities associated with positioning (e.g., three position coordinates and clock deviation from satellite time, etc.).

Each SV 502 may broadcast the GNSS signal 504 (e.g., a carrier wave with modulation) continuously that may include a pseudorandom code (e.g., a sequence of ones and zeros) which may be known to the GNSS device 506, and may also include a message that includes a time of transmission and the SV position at that time. In other words, each GNSS signal 504 may carry two types of information: time and carrier wave (e.g., a modulated waveform with an input signal to be electromagnetically transmitted). Based on the GNSS signals 504 received from each SV 502, the GNSS device 506 may measure the time of arrivals (TOAs) of the GNSS signals 504 and calculate the time of flights (TOFs) for the GNSS signals 504. Then, based on the TOFs, the GNSS device 506 may compute its three-dimensional position and clock deviation, and the GNSS device 506 may determine its position on the Earth. For example, the GNSS device 506's location may be converted to a latitude, a longitude, and a height relative to an ellipsoidal Earth model. These coordinates may be displayed, such as on a moving map display, or recorded or used by some other system, such as a vehicle guidance system.

While the distance between a GNSS device and an SV may be calculated based on the time it takes for a GNSS signal to reach the GNSS device, the SV's signal sequence may be delayed in relation to the GNSS device's sequence. Thus, in some examples, a delay may be applied to the GNSS device's sequence, such that the two sequences are aligned. For example, to calculate the delay, a GNSS device may align a pseudorandom binary sequence contained in the SV's signal to an internally generated pseudorandom binary sequence. As the SV's GNSS signal takes time to reach the GNSS device, the SV's sequence may be delayed in relation to the GNSS device's sequence. By increasingly delaying the GNSS device's sequence, the two sequences may eventually be aligned.

The accuracy of GNSS based positioning may depend on various factors, such as satellite geometry, signal blockage, atmospheric conditions, and/or receiver design features/quality, etc. For example, GNSS receivers used by smartphones or smart watches may have lower accuracy compared to GNSS receivers used by vehicles and surveying equipments. To improve the accuracy of GNSS positioning (e.g., from meters to centimeters), a real time kinematics (RTK) technique or mechanism (which may collectively be referred to as an RTK engine hereafter) may be used for a positioning device (e.g., a UE, a surveying equipment, an automobile GNSS system, etc.). For example, an RTK engine may enable a positioning device to use correction information from a base station to mitigate one or more error sources in GNSS receiver pseudo-range (PR) and carrier-phase (CP) measurements, which may include satellite orbit error, satellite clock error, and/or atmospheric error, etc. Thus, better accuracy may be achieved by the positioning device.

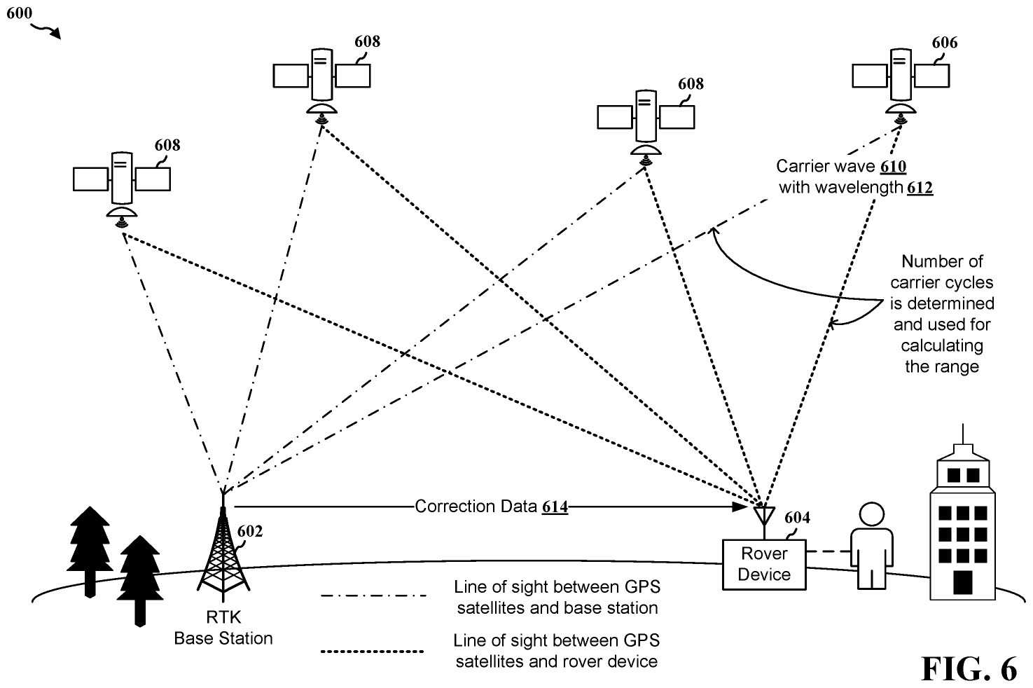

FIG. 6 is a diagram 600 illustrating an example of an RTK positioning in accordance with various aspects of the present disclosure. In one example, at least two receivers may be used in association with the RTK positioning, where at least one of the receivers may be stationary, which may be referred to as a base station 602 or an RTK base station, and at least one other receiver may be mobile (e.g., may be moving from time to time), which may be referred to as a rover or a rover device 604 (e.g., a GNSS/GPS receiver, a UE, a rover station, etc.). In other words, an RTK system may include at least a base station and a rover, where the base station may be a stationary receiver whose location is known.

A range between an SV 606 (e.g., a GNSS/GPS satellite) and the rover device 604 or between the SV 606 and the base station 602 may be calculated by determining a number of carrier cycles between the SV 606 and the rover device 604 or the base station 602, and multiplying this number by the carrier wavelength 612 of a carrier wave 610 (e.g., a carrier signal) transmitted by the SV 606. For example, if the SV 606 is transmitting a carrier wave 610 with a carrier wavelength 612 of ten (10) meters, and the rover device 604 receives the carrier wave 610 and determines that there are five hundred (500) carrier cycles between the SV 606 and the rover device 604, then the rover device 604 may calculate the distance between the SV 606 and the rover device 604 by multiplying the number of carriers cycles determined (e.g., 500) with the carrier wavelength 612 (e.g., 10 meters), which may be five thousand meters (e.g., 500×10=5000). Similarly, the base station 602 may also receive the carrier wave 610 from the SV 606 and determine its ranges from the SV 606 based on the carrier wavelength 612 of the carrier wave 610 and the number of carrier cycles between the base station 602 and the SV 606. The rover device 604 and/or the base station 602 may calculate ranges (e.g., distances) between the rover device 604/base station 602 and multiple (e.g., four or more) SVs (e.g., SVs 606 and 608) to determine their geographical locations (e.g., their locations on the Earth).

During the RTK positioning, the rover device 604 (e.g., a UE, a client device, etc.) may undergo an “ambiguity resolution” process to determine the number of carrier cycles between the SV 606 and the rover device 604. In other words, when the rover device 604 receives a carrier wave from an SV 606, it may take time for the rover device 604 to figure out how many carrier cycles are between the SV 606 and the rover device 604. In some examples, a GNSS receiver with more sophisticated or high-end antenna/hardware, such as an automotive grade antenna, may be able to resolve the ambiguity within a relatively short time (e.g., within seconds), while a GNSS receiver with less sophisticated or low-end antenna/hardware, such as antenna for mobile phone, and/or a smart watch, may take a longer time (e.g., 10-30 minutes or more) to resolve the ambiguity. In some examples, the ambiguity may also be referred to as an “integer ambiguity.” In some examples, the process of a GNSS receiver resolving the ambiguity may be referring to as converging, and the time it takes a device to resolve the ambiguity may be referred to as a convergence time.

In some scenarios, ranges calculated by the rover device 604 may include errors due to SV clock and ephemerides, and ionospheric and tropospheric delays, etc. Also, as the rover device 604 is more likely to be moving, the quality of a signal/carrier wave received from each SV may change as the rover device moves from one location to another location. For example, if the rover device 604 moves from an open sky area to an area with buildings, signals from one or more SVs 606/608 may be blocked/reflected by the buildings. As such, ranges calculated by the rover device 604 may start to drift and may include error(s).

On the other hand, as the base station 602 is likely to be stationary with a known location, and the base station 602 may be equipped with a more sophisticated and high-end GNSS receiver, the base station 602 may be able to maintain an accurate calculation for the ranges compared to the rover device 604. For example, the base station 602 may be located at a site (e.g., an open sky area) that has minimal environmental effects such as interference and multipath. As such, under the RTK positioning, as the base station 602 may have known its location already (e.g., via pre-surveying), the base station 602 may perform a measurement for an SV to obtain a base receiver measurement (e.g., to estimate a difference between the base station and the SV). Then, the base station 602 may minus the geometry distance between the base station location to SV location from the base receiver measurement to obtain a base correction (e.g., based on a difference or an error). The base station 602 may generate a correction data 614 (or a correction signal) based on the obtained base correction and transmit the correction data 614 to the rover device 604 to assist the rover device 604 in correcting the errors. For example, as the rover device 604 may typically be configured to locate in proximity to the base station 602 (e.g., within 6 miles, 12 miles, etc.), the rover device 604 is likely to encounter similar errors as the base station 602 (e.g., similar ionospheric and tropospheric delays, etc.). Thus, the rover device 604 may use the correction data 614 from the base station 602 to improve and expedite its own computed position from the GNSS constellations to achieve centimeter precision. In other words, a base station may be configured to stay in a fixed/known location and send correction data to one or more rover devices, and the one or more rover devices may use the correction data to increase the precision of their positioning and also the speed of error correction. As such, the rover device 604 may determine its position using algorithms that incorporate ambiguity resolution and differential correction. The position accuracy achievable by the rover device 604 may depend on its distance from the base station 602 and the accuracy of the differential corrections (e.g., the correction data 614).

In addition to Global Navigation Satellite Systems (GNSS)-based positioning (e.g., as described in connection with FIG. 5) and network-based positioning (e.g., as described in connection with FIG. 4), various camera-based positioning has also been developed to provide alternative/additional positioning mechanisms/modes. Camera-based positioning, which may also be referred to as “camera-based visual positioning,” “visual positioning” and/or “vision-based positioning,” is a positioning mechanism/mode that uses images captured by at least one camera to determine the location of a target (e.g., a UE or a transportation that is equipped with the at least one camera, an object that is in the field-of-view (FOV) of the at least one camera, etc.). For example, images captured by the dashboard camera (dash cam) of a vehicle may be used for calculating the three-dimensional (3D) position and/or the 3D orientation of the vehicle while the vehicle is moving. Similarly, images captured by the camera of a mobile device may be used for estimating the location of the mobile device or the location of one or more objects in the images. In another example, a camera (or a UE) may determine its position by matching object(s) in images captured by the camera (or the UE) with object(s) in a map (e.g., a high-definition (HD) map), such as specified building(s), landmark(s), road/street sign(s), etc. In some implementations, camera-based positioning may provide centimeter-level and 6-degrees-of-freedom (6DOF) positioning. 6DOF may refer to a representation of how an object moves through a 3D space by either translating linearly or rotating axially (e.g., 6DOF=3D position+3D attitude). For example, a single-degree-of-freedom on an object may be controlled by the up/down, forward/back, left/right, pitch, roll, or yaw. Camera-based positioning may have great potential for various applications, such as in satellite signal (e.g., GNSS/GPS signal) degenerated/unavailable environments.

In some scenarios, images captured by a camera may also be used for improving the accuracy/reliability of other positioning mechanisms/modes (e.g., the GNSS-based positioning, the network-based positioning, etc.), which may be referred to as “vision-aided positioning,” “vision-aided precise positioning (VAPP),” “camera-aided positioning,” “camera-aided location,” and/or “camera-aided perception,” etc. For example, while positioning technology using GNSS and inertial measurement unit (IMU) coupling may enable highly accurate location solutions. When a GNSS measurement outage occurs (e.g., GNSS signals are unavailable or weak), however, the IMU bias drifting may degrade the accuracy of the positioning. Such IMU bias may also lead to initial sensor alignment and/or heading ambiguity with a static start. In other words, while GNSS and/or an IMU may provide good positioning/localization performance, when a GNSS measurement outage occurs, the overall positioning performance might degrade due to IMU bias drifting. Using camera vision opportunistically, challenged faced by the GNSS and IMU GNSS coupling solution may be mitigated with useful and reliable vision features. For example, images captured by a camera may provide valuable information to reduce errors. For purposes of the present disclosure, a positioning session (e.g., a period of time in which one or more entities are configured to determine the position of a UE or a target) that is associated with camera-based positioning or camera-aided positioning may be referred to as a camera-based positioning session or a camera-aided positioning session. In some examples, the camera-based positioning and/or the camera-aided positioning may be associated with an absolute position of the UE, a relative position of the UE, an orientation of the UE, or a combination thereof.

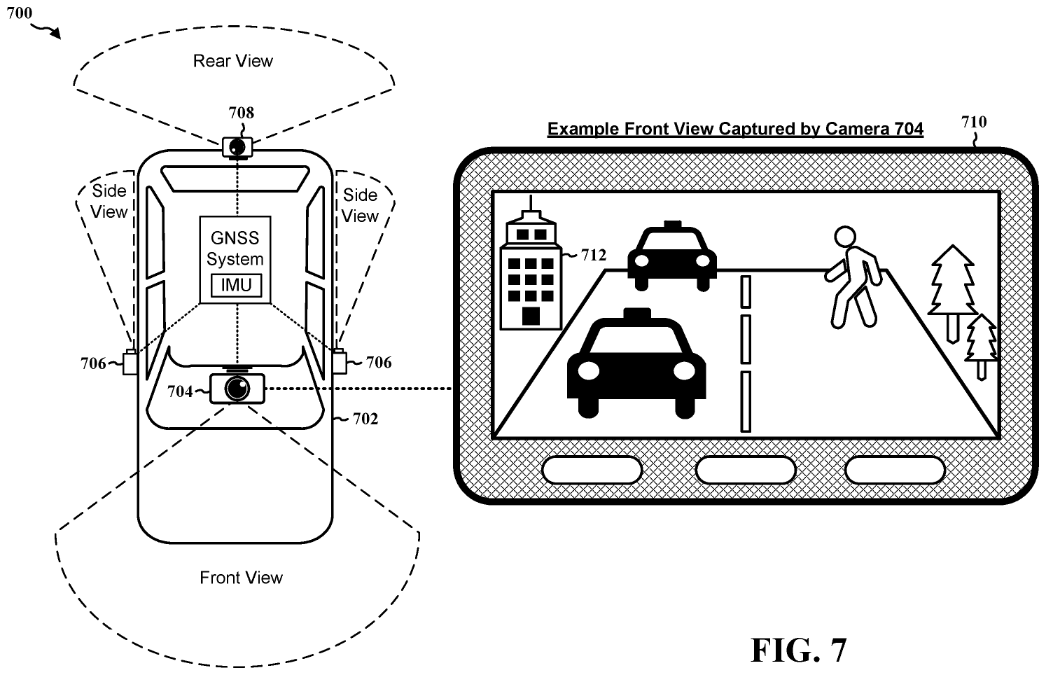

FIG. 7 is a diagram 700 illustrating an example of camera-aided positioning in accordance with various aspects of the present disclosure. A vehicle 702 may be equipped with a GNSS system and a set of cameras, which may include a front camera 704 (for capturing the front view of the vehicle 702), side cameras 706 (for capturing the side views of the vehicle 702), and/or a rear camera 708 (for capturing the rear view of the vehicle 702), etc. In some examples, the GNSS system may further include or be associated with at least one IMU (which may be referred to as a “GNSS+IMU system”). While FIG. 7 uses the vehicle 702 as an example, it is merely for illustration purposes. Aspects presented herein may also apply to other types of transportations (e.g., motorcycles, bicycles, buses, trains, etc.), devices (e.g., UEs on pedestrians), and/or positioning mechanisms/modes (e.g., network-based positioning described in connection with FIG. 4). In addition, for purposes of the present disclosure, a positioning mechanism/mode (e.g., GNSS-based positioning, network-based positioning, etc.) that uses at least one sensor (e.g., an IMU, a camera, etc.) to assist the positioning may be referred to as a “sensor fusion positioning.”

The GNSS system may be used for estimating the location of the vehicle 702 based on receiving GNSS signals transmitted from multiple satellites (e.g., based on performing GNSS-based positioning). However, when the GNSS signals are not available or weak (which may be referred to as a GNSS outage), such as when the vehicle 702 is in an urban area or in a tunnel, the estimated location of the vehicle 702 may become inaccurate. Thus, in some implementations, the set of cameras on the vehicle 702 may be used for assisting the positioning, such as for verifying whether the location estimated by the GNSS system based on the GNSS signals is accurate. For example, as shown at 710, images captured by the front camera 704 of the vehicle 702 may include/identify a specific building 712 (which may also be referred to as a feature) that is with a known location, and the vehicle 702 (or the GNSS system or a positioning engine associated with the vehicle 702) may determine/verify whether the location (e.g., the longitude and latitude coordinates) estimated by the GNSS system is in proximity to the known location of this specific building 712. Thus, with the assistance of the camera(s), the accuracy and reliability of the GNSS-based positioning may be further improved. For purposes of the present disclosure, a GNSS system that is associated with a camera (e.g., capable of performing camera-aided/based positioning) may be referred to as a “GNSS+camera system,” or a “GNSS+IMU+camera system” (if the GNSS system is also associated with/includes at least one IMU). A vision-aided positioning mechanism that is capable of achieving a high-level positioning accuracy (e.g., meeting a defined precision threshold) may be referred to as vision-aided precise positioning (VAPP).

In some examples, a software or an application that accepts positioning related measurements from GNSS chipset(s), sensor(s), and/or camera(s) to estimate the position, the velocity, and/or the altitude of a device (or a target) may be referred to as a positioning engine (PE). Similarly, a positioning engine that is capable of achieving certain high level of accuracy (e.g., a centimeter/decimeter level accuracy) and/or latency may be referred to as a precise positioning engine (PPE). For example, a positioning engine that is capable of performing real-time kinematic positioning (RTK) (e.g., receiving or processing correction data associated with RTK as described in connection with FIG. 6) may be considered as a PPE. Another example of PPE is a positioning engine that is capable of performing precise point positioning (PPP). PPP is a positioning technique that removes or models GNSS system errors to provide a high level of position accuracy from a single receiver.

In some examples, a navigation application/software may refer to an application/software in a user equipment (e.g., a smartphone, an in-vehicle navigation system, a GPS device, etc.) that is capable of providing navigational directions in real time. Over the last few years, users have increasingly relied on navigation applications because they have provided various benefits. For example, navigation applications may provide convenience to users as they enable users to find a way to their destinations, and also allow users to contribute information and mark places of importance thereby generating the most accurate description of a location. In some examples, navigation applications are also capable of providing expert guidance for users, where a navigation application may guide a user to a destination via the best, most direct, or most time-saving routes. For example, a navigation application may obtain the current status of traffic, and then locate a shortest and fastest way for a user to reach a destination, and also provide approximately how long it will take the user to reach the destination. As such, a navigation application may use an Internet connection and a GPS/GNSS navigation system to provide turn-by-turn guided instructions on how to arrive at a given destination.

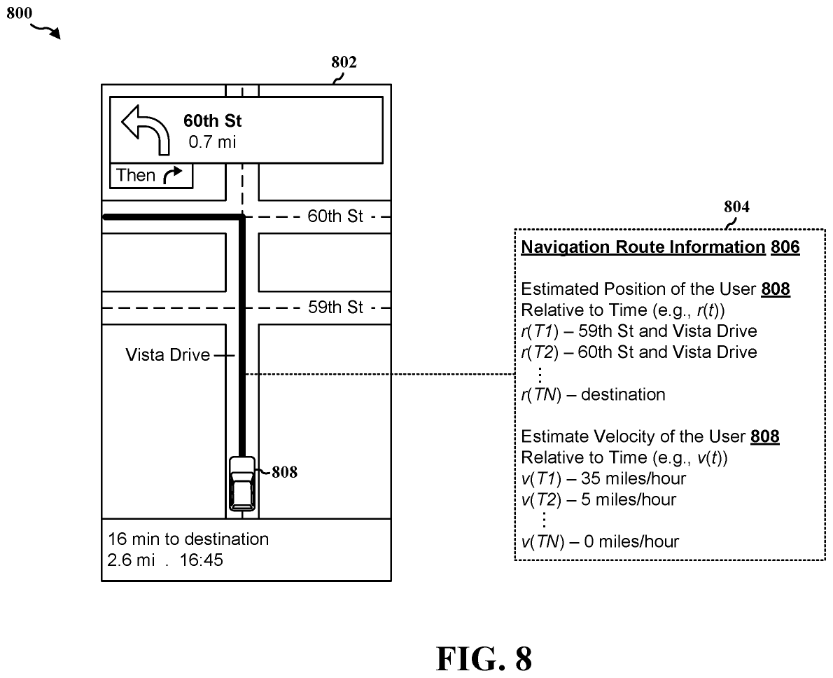

FIG. 8 is a diagram 800 illustrating an example of a navigation application in accordance with various aspects of the present disclosure. As shown at 802, a navigation application, which may be running on a UE such as a vehicle (e.g., a built-in GPS/GNSS system of the vehicle) or a smartphone, may provide a user (e.g., via a display or an interface) with turn-by-turn directions to a destination and an estimated time to reach the destination based on real-time information. For example, the navigation application may receive/download real-time traffic information, road condition information, local traffic rules (e.g., speed limits), and/or map information/data from a server. Then, the navigation application may calculate a route to the destination based on at least the map information and other available information. The map information may include the map of the area in which the user is traveling, such as the streets, buildings, and/or terrains of the area, or a map that is compatible with the navigation application and GPS/GNSS system. In some examples, the route calculated by the navigation application may be the shortest or the fastest route. For purposes of the present disclosure, information associated with this calculated route may be referred to as navigation route information. For example, navigation route information may include predicted/estimated positions, velocities, accelerations, directions, and/or altitudes of the user at different points in time.

For example, as shown at 804, based on the map information, the speed limit, and the real-time road condition information, the navigation application may generate navigation route information 806 that guides a user 808 to a destination. In some examples, the navigation route information 806 may include the position of the user and velocity of the user relative/respect to time, which may be denoted as \vec{r}(t) and \vec{v}(t), respectively. For example, the navigation application may estimate that at a first point in time (T1), the user may reach a first point/place with certain speed (e.g., the intersection of 59th Street and Vista Drive with a velocity of 35 miles per hour), and at a second point in time (T2), the user may reach a second point/place with certain speed (e.g., the intersection of 80th Street and Vista Drive with a velocity of 15 miles per hour), and up to N^{th} point in time (TN), etc.

In recent years, vehicle manufacturers have been developing vehicles with autonomous driving capabilities. Autonomous driving, which may also be called as self-driving or driverless technology, may refer to the ability of a vehicle to navigate and operate itself without specifying human intervention (e.g., without a human controlling the vehicle). The goal of the autonomous driving is to create vehicles that are capable of perceiving their surroundings, making decisions, and controlling their movements, all without the direct involvement of a human driver.

To achieve or improve the autonomous driving, a vehicle may be specified to use a map (or map data) with detailed information, such as a high-definition (HD) map. An HD map may refer to a highly detailed and accurate digital map designed for use in autonomous driving and advanced driver assistance systems (ADAS). In one example, HD maps may typically include one or more of: (1) geometric information (e.g., precise road geometry, including lane boundaries, curvature, slopes, and detailed 3D models of the surrounding environment), (2) lane-level information (e.g., information about individual lanes on the road, such as lane width, lane type (e.g., driving, turning, or parking lanes), and lane connectivity), (3) road attributes (e.g., data on road features like traffic signs, signals, traffic lights, speed limits, and road markings), (4) topology (e.g., information about the relationships between different roads, intersections, and connectivity patterns), (5) static objects (e.g., locations and details of fixed objects along the road, such as buildings, traffic barriers, and poles), (6) dynamic objects (e.g., real-time or frequently updated data about moving objects, like other vehicles, pedestrians, and cyclists), and/or (7) localization and positioning: precise reference points and landmarks that help in accurate vehicle localization on the map, etc. In some implementations, a HD-map may also include real-time information, such as traffics, obstacles, constructions, road closures, and/or weather conditions of different areas/roads. As HD maps are capable of providing detailed and up-to-date information about the road network, including lane-level data, traffic signs, road markings, and other important features, etc., HD maps may be an important aspect for enabling autonomous vehicles to navigate complex environments and make informed decisions in real-time.

As described in connection with FIGS. 7 and 8, while a precise positioning technology using GNSS and IMU coupling may provide highly accurate location solutions, the IMU bias drifting may degrade the positioning accuracy during a GNSS outage. Such IMU bias may also lead to initial sensor alignment and/or heading ambiguity with a static start. Thus, camera visions may be used (by a positioning device such as a UE) for mitigating or reducing errors under such scenarios. In some examples, maps (e.g., HD maps) for positioning and/or navigations may be used to verify the image fidelity of vision-aided positioning. In some examples, using an external precise position source (e.g., a landmark, a radio frequency (RF) identifier/identification (ID), a surveillance camera, a network-based precise location, etc.) as a seed in form of pseudo measurement, the convergence time for a positioning engine or a PPE may be largely reduced. In some scenarios, when vision-aided positioning starts (or is triggered/activated), a certain amount of convergence time may also be specified for a precise positioning solution due to IMU bias calibration and feature tracking. Thus, vision-aided positioning may be greatly improved if the convergence time (or the re-convergence time) of the vision-aided positioning can be reduced.

Aspects presented herein may improve (e.g., reduce) the convergence time for vision-aided positioning, such as VAPP. Aspects presented herein may provide a rapid localization for vision-aided positioning by enabling images embedded with location information to be used for removing (common) perception errors in a positioning device (e.g., such as during a GNSS outage). In one aspect of the present disclosure, the convergence time of vision-based positioning may be reduced based on using common visual feature(s) (e.g., cooperative VAPP using common visual feature), where a positioning device (e.g., a UE, a camera, a vehicle, a positioning engine, etc.) may select a set of common environmental features nearby for a fast localization (e.g., for determining the position and/or the attitude). In some implementation, when such common feature(s) are not detected/available, the positioning device may also use artificial feature(s) that are created and customized. In another aspect of the present disclosure, the convergence time of vision-based positioning may be reduced based on map data assistance (e.g., HD map assistance), where a positioning device may perform feature matching with maps (e.g., HD maps) to obtain external precise location source, perform UE time (dynamic) model enhancement with maps, and/or perform RF-based (GNSS) positioning error modelling based on maps, etc.

In one aspect of the present disclosure, a reference system may be used by assist a UE with the vision-aided positioning, which may be referred to as “cooperative positioning” or “cooperative vision-aided positioning” for purposes of the present disclosure. The reference system may include a GNSS chipset, at least one IMU, and at least one camera (e.g., a GNSS+IMU+camera system), where the reference system's 6DOF (e.g., position and attitude) may have been already converged. Then, a UE (e.g., a mobile device or a vehicle that also includes a GNSS+IMU+camera system) may be configured to detect/see a set of a set of common environmental features that are being tracked by the reference system. The location(s) for the set of common environmental features may be configured to be a function of a camera's 6DOF (e.g., based on 3D position and 3D altitude of the camera). Also, the relative orientation(s) between the set of common environmental features may be different with respect to the UE or the reference system.

The reference system may share (broadcast) the following information to the UE: the reference system's 6DOF (e.g., 3D position and 3D attitude), real-time GNSS measurements (e.g., in observation state representation (OSR) format), and/or real-time tracking feature(s) and the location of each feature. Based on the information from the reference system (which may be referred to as “reference system data”), the 6DOF estimation process of the UE may be quickly initialized and converged with reference system data. For example, as the absolute location(s) of commonly seen feature(s) may be known, the position uncertainty of the UE may be reduced significantly based on the information from the UE's camera and information from the reference system's feature location. In addition, based on using GNSS measurement(s) from the reference system, PPP/RTK may also be fixed/converged much faster (e.g., much smaller search space for integer ambiguity resolution (IAR)). An IAR may refer to a process in GNSS/GPS positioning, such as in applications like RTK and PPP, where a GNSS/GPS receiver use signals from multiple satellites to determine the user's position accurately. The process of determining the user's position typically involves two types of ambiguities: the carrier phase ambiguities and the code phase ambiguities, where an IAR process may involve finding the correct integer values for the carrier phase ambiguities.

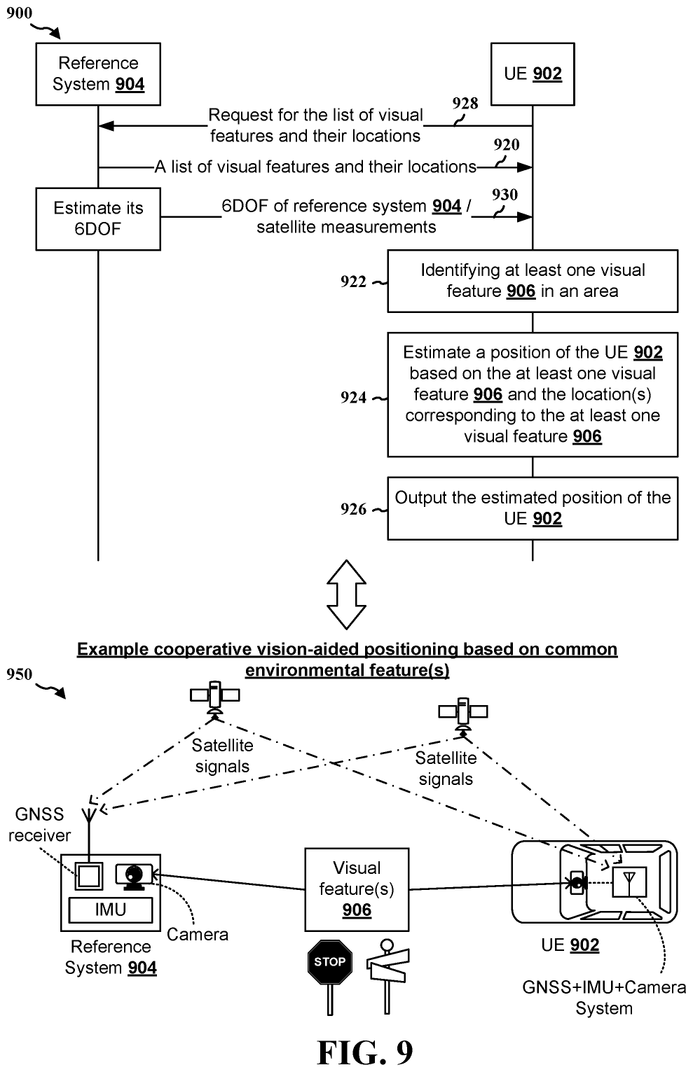

FIG. 9 is a communication flow 900 illustrating an example of cooperative vision-aided positioning based on common environmental feature(s) in accordance with various aspects of the present disclosure. The numberings associated with the communication flow 900 do not specify a particular temporal order and are merely used as references for the communication flow 900.

As shown at 950, a UE 902 (e.g., a mobile device, a positioning device, a navigation device, a vehicle, etc.) may include a satellite signal receiver/chipset (e.g., a GNSS/GPS receiver/chipset) that enables the UE 902 to determine its position based on reception of satellite signals (e.g., based on GNSS/GPS signals as described in connection with FIGS. 5 and 6), at least one IMU, and at least one camera (e.g., the UE 902 may include a GNSS+IMU+camera system). A reference system 904 (which may be another UE, another mobile device, a base station, a server, a roadside unit (RSU), a network node/entity, etc.) may also include a satellite signal receiver/chipset that enables the reference system 904 to determine its position based on reception of satellite signals, at least one IMU, and at least one camera (e.g., the reference system 904 may also include a GNSS+IMU+camera system). The six degrees of freedom (6DOF) of the reference system 904 may have already been converged.

At 920, the UE 902 may receive, from the reference system 904 (or via a server), a list of visual features and their corresponding locations. For example, the reference system 904 or the server may broadcast the list of visual features and their corresponding locations to one or more UEs within specified area(s), and UEs within the specified area(s) may receive the list of visual features and their corresponding locations broadcasted by the reference system 904 or the server. A visual feature may refer to a visual characteristic that is associated with an object. For example, a visual feature may be a specified object/building, a color pattern of an object/building, a contour of an object/building, a portion/part of an object/building, and/or an environment, such as a road/street sign, words in the road/street sign, a high-rise building, a landmark, etc. In some implementations, the visual feature may be configured to be a function of the 6DOF of the reference system 904 (or of a camera of the reference system 904). For example, a visual feature (e.g., a specified portion of a building) may be selected based on the 6DOF of a camera of the reference system 904). In some examples, a visual feature may be invisible to human eyes, but may be visible to machine visions (e.g., infrared, ultraviolet, X-ray, and gamma-ray, etc.).

At 922, based on the list of visual features and their corresponding locations received from the reference system 904 (or via the server), the UE 902 may be configured to identify at least one visual feature 906 (or a combination of visual features) in an area via its camera(s), where the at least one visual feature 906 (or the combination of visual features) is included in the list of visual features. The area and/or the at least one visual feature 906 may be specified to be within a threshold distance of the UE 902. For example, the UE 902 may be configured to search for visual feature(s) within one kilometer or 300 feet of the UE 902.

At 924, based on the at least one visual feature 906 and the location(s) corresponding to the at least one visual feature 906, the UE 902 may estimate its position (e.g., absolute position, relative position, etc.) or using such information to assist the convergence of its positioning engine (e.g., by reducing the search space for its RTK/PPP module(s) and/or IAR process). In other words, the UE 902 may perform vision-aided positioning or VAPP based on the at least one visual feature 906. For example, instead of performing an IAR process for a search space that is 10 kilometers (KM) in diameter, the UE 902 may use the location of the at least one visual feature 906 to narrow down the search space to just 1 kilometer in diameter. In another example, if the exact/absolute location of the at least one visual feature 906 is known, the UE 902 may also be able to determine its exact/absolute location and/or its relative location from the at least one visual feature 906. In some examples, the UE 902 may also use the at least one visual feature 906 to determine its past position(s) and/or to estimate/predict its future position(s). For example, if the at least one visual feature 906 corresponds to a landmark and the UE 902 is moving toward that landmark, the UE 902 may predict or calculate its' future position(s) and/or past position(s) with respect to the landmark.

At 926, depending on the implementations, the UE 902 may output its estimated position (e.g., to another entity or application) or store the estimated position in a memory. For example, if the UE 902 is a positioning engine or a positioning device, the UE 902 may transmit the estimated position to a positioning server (e.g., a location management function (LMF)) or a navigation application, etc.

In some examples, the reference system 904 may transmit the list of visual features and their locations based on a request from the UE 902. For example, as shown at 928, the UE 902 may transmit, to the reference system 904, a request for the list of visual features and their corresponding locations. In response, the reference system 904 may transmit the list of visual features and their corresponding locations to the UE 902 based on the request as shown at 920.

In another example, as shown at 930, the reference system 904 may also estimate its 6DOF and/or provide its 6DOF information and/or satellite measurements (e.g., GNSS/GPS measurements) to the UE 902 to further assist the UE 902 with the positioning. For example, the UE 902 may use the GNSS/GPS measurements from the reference system 904 to improve/reduce its convergence time (or the convergence time of its positioning engine). For example, the UE 902 may initiate a 6DOF estimation process for a positioning engine based on the location corresponding to the at least one visual feature 906, the 6DOF of the reference system 904, and the real-time GNSS measurements from the reference system 904. Then, the UE 902 may be able to calculate its position (with certain precision) after the positioning engine converges.

The reference system 904 may transmit the list of visual features and their locations (e.g., as shown at 920) and its 6DOF information and/or satellite measurements (e.g., as shown at 930) via the same message or via separated/different messages. In addition, the reference system 904 may also transmit the message(s) via unicast message(s) (e.g., message(s) dedicated to the UE 902) or via broadcast message(s) (e.g., message(s) for multiple UEs, UEs within an area, UEs satisfying certain conditions, etc.).

Aspects described in connection with FIG. 9 may enable a reference system (e.g., the reference system 904) to provide its 6DOF (e.g., 3D position and 3D attitude), GNSS measurements (e.g., in an OSR format), and a list of tracking features and their location to a UE (e.g., the UE 902). When the UE identifies a common feature (e.g., a stop sign, a landmark, etc.) that is being tracked, the UE may can compute its own position or distance (e.g., a circle of position) around that common feature (e.g., around the step sign, around the landmark, etc.). Then RTK and/or PPP IAR module(s) of the UE may be triggered with a much smaller search space, such that IAR may be fixed and UE precise positioning may be obtained with a much shorter convergence time.

In another aspect of the present disclosure, the cooperative vision-aided positioning (e.g., a vision-aided positioning performed by two or more entities) may also be configured to use artificial/virtual features or artificial/virtual environmental features. For purposes of the present disclosure, an artificial/virtual feature or an artificial/virtual environmental feature may refer to a feature or a thing that is purposely created for the cooperative vision-aided positioning (e.g., for a UE to perform vision-aided positioning based on this feature). In some examples, the artificial/virtual feature may be visible to a camera or a machine vision, but may not be visible to a human eye.

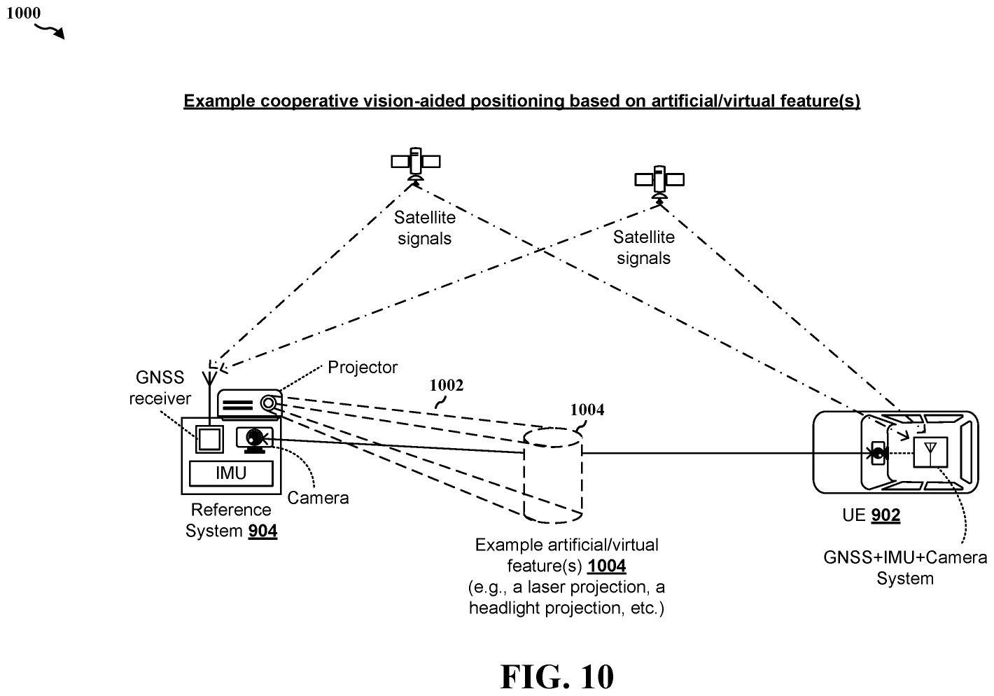

FIG. 10 is a diagram 1000 illustrating an example of cooperative vision-aided positioning based on artificial/virtual feature(s) in accordance with various aspects of the present disclosure. As shown at 1002, a reference system (e.g., the reference system 904) may be configured to use a projector to (actively) create and customize a set of artificial features 1004, such as using a laser projection on a 2D surface (e.g., a 2D projection on a surface of a road or a surface of a building, etc.) or on a 3D space (e.g., a 3D projection on a road intersection), etc. The projector may be part of (e.g., allocated with) the reference system, or separated from the reference system (e.g., multiple projectors may be allocated at different areas and controlled by the reference system). In some examples, if the reference system is another vehicle/UE, the set of artificial features 1004 may be created using the vehicle's headlights or the UE's light. Then, as described in connection with 920 of FIG. 9, when the reference system 904 transmits a list of visual features and their locations to the UE 902, the list of visual features may also include a set of artificial/virtual feature(s) and their locations. For example, the reference system 904 may create a visual feature at a specified location (or cause the visual feature to be generated at the specified location), and the UE 902 may try to capture/detect the created visual feature and use such visual feature for determining its location or for converging its positioning engine, such as described in connection with 924 of FIG. 9.

In some implementations, the reference system may also be configured to intentionally create the artificial feature(s) in the field-of-view of the UE (e.g., instead of pre-configuring at fixed locations). For example, if the reference system is able to know the approximate/coarse location of the UE and/or the direction/heading of the UE (e.g., provided by the UE or obtained via another entity), the reference system may create the artificial feature(s) that are in the heading direction of the UE and/or surrounding the UE (to enable at least one camera of the UE to capture the artificial feature(s)). For example, if the reference system determines that the UE is currently near an intersection, the reference system may create a set of artificial features in that intersection and also around the intersection.

In another aspect of the present disclosure, in addition to or as an alternative to the reference system creating artificial virtual feature(s), the UE may also be configured to create artificial/virtual feature(s), such as using its headlight(s) to illuminate a unique identifier or pattern. In response, the reference system may try to detect and track the artificial/virtual feature(s) created by the UE (e.g., using one or more cameras that may or may not be allocated with the reference system). If the reference system is able to detect and track the artificial/virtual feature(s) created by the UE, the reference system may be able to identify the location of the UE and notify the UE with regards to the UE's location. For example, the reference system may have a camera at a specified intersection. When a UE creating a unique artificial/virtual feature passes that intersection and is detected by a camera of the reference system, the reference system may identify that the UE is currently around that intersection and notify the UE regarding its location (and the UE may use this information to determine its position and/or to reduce the converge time of its positioning engine).

The artificial/virtual feature described in connection with FIG. 10 may be useful when there is no common (e.g., non-artificial) feature(s) that can be used by the reference system and the UE as references, such as when the UE is in a tunnel, in a garage, or at a night-time countryside where the environment may not be able to offer much trackable visual features.

In another aspect of the present disclosure, a UE (e.g., the UE 902) may also use information in a map or map data to perform or assist vision-based positioning, such as determining its position and/or reducing the convergence time of its positioning engine based on matching features in the map or map data with images captured by the UE (or by the camera of the UE). For example, as described above, a high-definition (HD) map may be a highly detailed and accurate digital map that includes real-time information, where some of the information may be used by a UE for determining its location (e.g., absolute location or relative location, etc.)

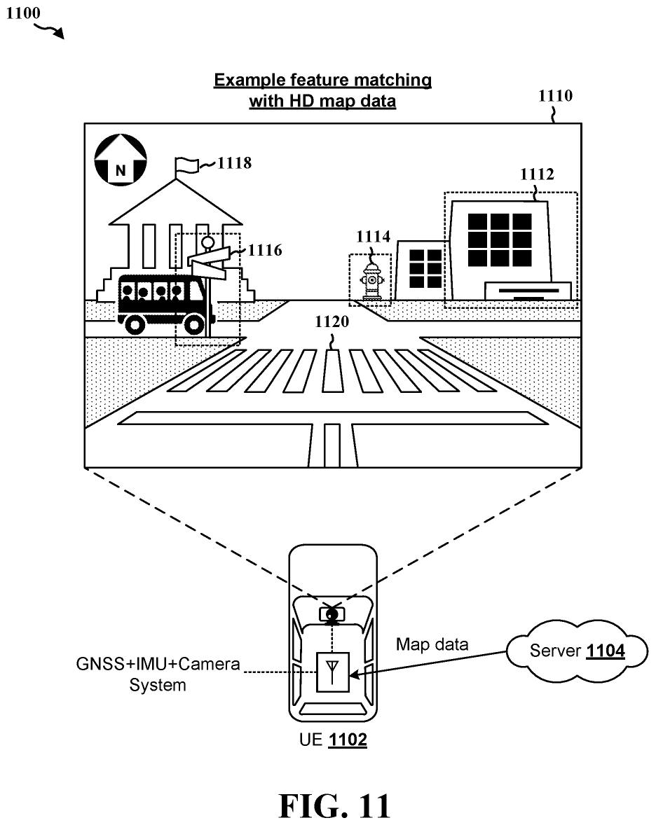

FIG. 11 is a diagram 1100 illustrating an example of vision-aided positioning based on feature matching with map(s) in accordance with various aspects of the present disclosure. In one example, map data (or a set of maps), such as HD map data or HD maps, may include both invariant and variant components. Invariant components (which may also be called invariant features) may refer to objects (e.g., in a real world) that are likely to be invariant (e.g., remain unchanged) for a relatively long period of time. For example, as shown at 1110, the building 1112, the fire hydrant 1114, and/or the road sign 1116 are likely to be considered as invariant components as they are more likely to remain unchanged for a relatively long period of time (e.g., typically last for at least months or years). On the other hand, variant components (which may also be called variant features) may refer to objects that are more likely to change within a relatively short period of time (e.g., typically within few months, days, etc.). For example, the flag 1118 and the crosswalk 1120 are likely to be considered as variant components as they may change after a shorter period of time compared to the invariant components (e.g., the shape of the flag 1118 may change depending on the wind direction, and the color and contour of the crosswalk 1120 may fade or wear off over time, etc.).

In one example, a UE 1102 may achieve rapid localization (or faster convergence time) for vision-based positioning using information provided by map data, such as by matching invariant features or FOV in the map data with features or FOV from images/views captured by the UE 1102 (via at least one camera of the UE 1102). In some examples, the map(s) used by the UE 1102 may be stored at a local database or a local map database of the UE 1102. A local database or a local map database may refer to at least one memory that is located within the UE 1102 and is accessible to the UE 1102 directly (e.g., typically without going through another entity). In some examples, the UE 1102 may be configured to download the map data (or updated map data) from a server 1104 (e.g., a map server/database) periodically or based on certain conditions (e.g., when entering an area without map) to keep its local map database updated (e.g., for navigation and/or autonomous driving purposes, etc.). A local map database may refer to map data stored at a memory of the UE, which may be accessed by the UE without downloading from another source such as a server.

In one aspect, the UE 1102 may perform vision-aided positioning based on feature matching with map(s) using an object location seeding mechanism, where the UE 1102 may obtain location(s) of matching feature(s) directly from the map data or the server 1104. For purposes of the present disclosure, a matching feature may refer to a feature (e.g., an object, a building, a pattern, etc.) that is detected in an image/FOV captured by the UE which matches the same feature in a map/map data. For example, as shown at 1110, the UE 1102 may be able to identify features such as the building 1112, the fire hydrant 1114, and/or the road sign 1116 from images/FOV captured by the UE 1102, and the UE 1102 may match them with the same building, fire hydrant and/or the road sign in the map data. Thus, these features may be referred to as matching features.

Based on these matching features, the UE 1102 may be able to determine/obtain the exact/approximate location(s) of these matching features from the map data (e.g., the map data may include the locations of objects) or from the server 1104 (e.g., the UE 1102 may request the server 1104 to provide locations for these features). For example, as shown at 1110, after the UE 1102 identifies and matches the building 1112, the fire hydrant 1114, and/or the road sign 1116 from images/FOV captured by the UE 1102 with the same building, fire hydrant and/or the road sign in the map data, the UE 1102 may be able to know the exact/approximate location(s) of the building 1112, the fire hydrant 1114, and/or the road sign 1116 (e.g., the map data may include location information for these features such as their addresses or coordinates, etc.). Then, based on knowing their location(s), the UE 1102 may be able to determine its absolute/approximate location (e.g., relative location techniques may be used to solve the location of the UE) and/or its relative location from at least one of the features, etc. (e.g., 2 kilometers from southeast of the building 1112), and the UE 1102 may also use the determined location/relative location to enhance/reduce the convergence time of its positioning engine, such as described in connection with FIG. 9 (e.g., similar to using at least one visual feature 906 with their corresponding locations to achieve rapid localization/faster convergence for a positioning engine).

In another aspect, the UE 1102 may perform vision-aided positioning based on feature matching with map(s) using an FOV location seeding mechanism, where the UE 1102 may calculate and determine its 6DOF based on matching its FOV (e.g., a view/image captured by the UE 1102 via at least one camera) with the FOV from the map data. For example, if the UE 1102 is able to match its FOV as shown at 1110 with the same FOV from the map data, then the UE 1102 (or the server 1104) may be able to calculate and estimate the 6DOF of the UE 1102. In other words, based on the FOV for a map (e.g., a HD map that includes street views), the 6DOF of a viewer (e.g., a UE) may be determined from HD maps with feature/FOV matching (e.g., this may also be done in the server 1104 or via a cloud server, etc.). Then, based on knowing the 6DOF of the UE 1102, the UE 1102 may be able to determine its location (e.g., absolute, approximate, or relative location). For example, for a camera to capture the view shown at 1110 based on a set of camera settings (e.g., with a specified focal length, zoom, and/or resolution, etc.), the camera may be at a specified area (e.g., between 5-6 meters away from the intersection and facing north). Similarly, after determining its location, the UE 1102 may use the determined location to enhance/reduce the convergence time of its positioning engine and/or achieve a rapid localization for its positioning engine, such as described in connection with FIG. 9 (e.g., similar to using at least one visual feature 906 with their corresponding locations to achieve rapid localization/faster convergence for a positioning engine).

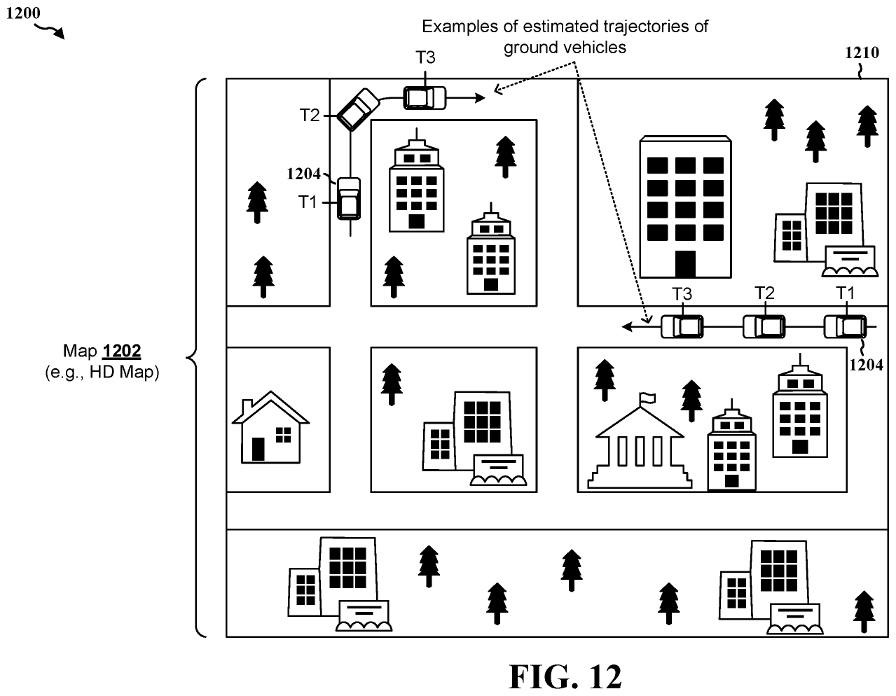

FIG. 12 is a diagram 1200 illustrating an example of a UE time (dynamic) model enhancement using maps (e.g., HD maps) in accordance with various aspects of the present disclosure. In another aspect of the present disclosure, as a map (e.g., a HD map) may offer a wide range of information including real-time information as described above, in some implementations, a map may also include trajectories for ground vehicle(s), e.g., positions of ground vehicles as a function of time: \vec{r}=f(t). For example, as shown at 1210, a map 1202 (e.g., a HD map) may include the trajectories for UEs 1204 (e.g., vehicles), such as their positions at a first point in time (T1), at a second point in time (T2), at a third point in time (T3), and up to an N^{th} point in time (TN).

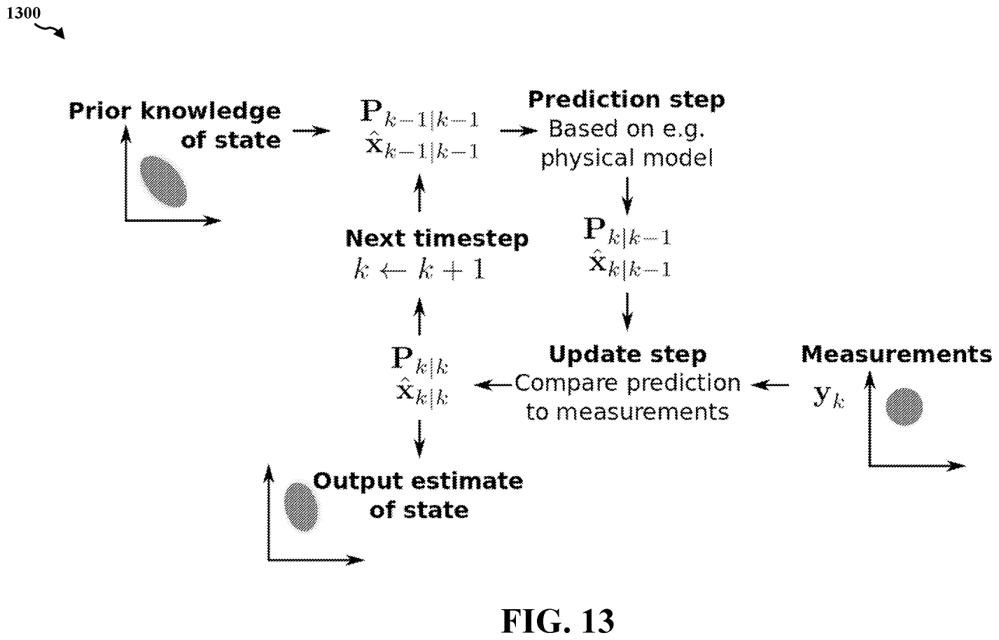

In one aspect, as a map (or map data) may also be capable of providing a relationship between height and latitude/longitude of a UE (e.g., the UE 902), this information may be used as holonomic constraints for (estimating) UE dynamic. For purposes of the present disclosure, a system may be classified/defined as holonomic if (all) constraints of the system are holonomic. For a constraint to be holonomic, the constraint may be specified to be expressible as a function (e.g., a holonomic constraint may depend just on the coordinates and maybe time). For example, when lane-level positioning is available (e.g., positioning with sufficient precision that enables a UE to determines which lane is travelled by the UE), the trajectory information shown at 1210 from the map 1202 may also be configured to feed into the positioning engine (of vision-aided positioning or VAPP) to enable the positioning engine (of the UE) to obtain a more accurate time (dynamic) model of the UE. Then, the obtained time (dynamic) model may be used in a Kalman filter (KF) process for state prediction based on a physical model, such as shown by a diagram 1300 of FIG. 13. A better time (dynamic) model may be beneficial to enable a UE to produce more accurate and faster localization (e.g., faster convergence time) in a challenging environment, such as in a deep urban area for GNSS/GPS positioning, and/or at during night-time for vision-based positioning.

In another aspect of the present disclosure, a UE (e.g., the UE 902) may also be configured to perform RF-based positioning error modelling using information from a map (e.g., an HD map), where radio frequency (RF)-based positioning may refer to positioning involving reception and/or transmission of RF (e.g., wireless) signals. For example, network-based positioning described in connection with FIG. 4 and GNSS-based positioning described in connection with FIGS. 5 and 6 may be referred to as RF-based positioning.

In some implementations, as a map (e.g., an HD map) may also contain environmental information (e.g., the weather condition, the temperature, the pollution level, etc.) and a (coarse) location of a UE (e.g., the UE 902) may be estimated from the map (e.g., based on the estimated position/trajectory of the UE 902 in the map as described in connection with FIG. 12), the UE's (coarse) location may be configured to be correlated with satellite (e.g., GNSS/GPS) measurement error(s) (e.g., in an observation state representation (OSR) format or a state space representation (SSR) format, etc.). Therefore, a map (or map data) may also be configured to include satellite (GNSS/GPS) measurement error budgets received from multiple sources (e.g., e.g., provided by a plurality of users), such as based on crowdsourcing or empirical modelling. For example, a group of UEs/vehicles may be configured to provide their GNSS/GPS measurements and errors to a cloud server. Then, the GNSS/GPS error budgets may be modelled to a specified format (e.g., the SSR format) based on the location input (of the UE providing the measurements). For example, error modelling with maps may be associated with multipath effects, where a 3D building model from a map may be used to model multipath with RF signal ray tracing. In another example, error modelling with maps may be associated with earth surface vibration as earth surface vibration (e.g., of a bridge, a railway, etc.,) may be highly depend on the environment, where for high precision positioning, a few centimeter offset variation may be induced from certain (special) location. In another example, error modelling with maps may be associated with satellite (GNSS/GPS) signal interference (e.g., based on a jamming and spoofing heatmap). In another example, error modelling with maps may be associated with atmospheric impact (e.g., ionospheric effect/impact and/or tropospheric effect/impact on satellite signals), where atmospheric impact may be obtained from a map (e.g., an HD map) by integration with real-time space and meteorological weather source. In some examples, the satellite (GNSS/GPS) total error budgets may also be modelled in an OSR format based on historical UE data.

Aspects presented herein are directed to enhancements related to vision-aided precise positioning (VAPP). Aspects presented herein include the followings aspects/features: 1) Cooperative VAPP using common visual features—(a) select common environment features nearby for fast localization (altitude and position), and (b) create and customize artificial features when no common feature is detected; 2) HD map assistance VAPP—(a) Feature matching with HD maps to obtain external precise location source, and (b) UE Time (Dynamic) model enhancement with HD maps, and (c) RF-based (GNSS) positioning error modelling based on HD maps.

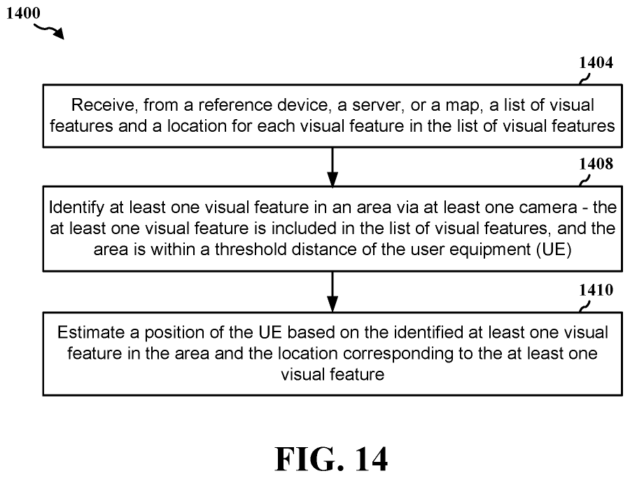

FIG. 14 is a flowchart 1400 of a method of wireless communication. The method may be performed by a UE (e.g., the UE 104, 404, 902, 1102; the GNSS device 506; the rover device 604; the vehicle 702; the apparatus 1604). The method may enable the UE to improve (e.g., reduce) the convergence time for vision-aided positioning by enabling the UE to use images embedded with location information.

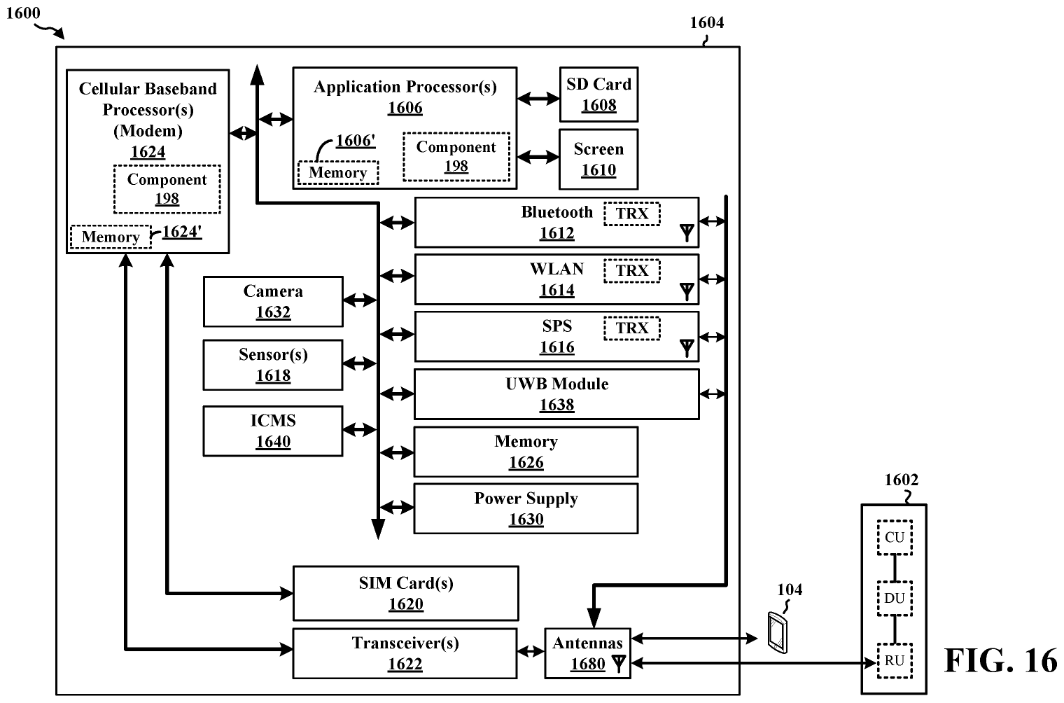

At 1404, the UE may receive, from a reference device, a server, or a map, a list of visual features and a location for each visual feature in the list of visual features, such as described in connection with FIGS. 9 to 12. For example, as discussed in connection with 920 of FIG. 9, the UE 902 may receive, from the reference system 904 (or via a server), a list of visual features and their corresponding locations. The reception of the list of visual features may be performed by, e.g., the vision-aided positioning component 198, the camera 1632, the one or more sensors 1618, the transceiver(s) 1622, the cellular baseband processor(s) 1624, and/or the application processor(s) 1606 of the apparatus 1604 in FIG. 16.

At 1408, the UE may identify at least one visual feature in an area via at least one camera, where the at least one visual feature is included in the list of visual features, where the area is within a threshold distance of the UE, such as described in connection with FIGS. 9 to 12. For example, as discussed in connection with 922 of FIG. 9, based on the list of visual features and their corresponding locations received from the reference system 904 (or via the server), the UE 902 may be configured to identify at least one visual feature 906 (or a combination of visual features) in an area via its camera(s), where the at least one visual feature 906 (or the combination of visual features) is included in the list of visual features. The ident cation of the at least one visual feature may be performed by, e.g., the vision-aided positioning component 198, the camera 1632, the one or more sensors 1618, the transceiver(s) 1622, the cellular baseband processor(s) 1624, and/or the application processor(s) 1606 of the apparatus 1604 in FIG. 16.

At 1410, the UE may estimate a position of the UE based on the identified at least one visual feature in the area and the location corresponding to the at least one visual feature, such as described in connection with FIGS. 9 to 12. For example, as discussed in connection with 924 of FIG. 9, based on the at least one visual feature 906 and the location(s) corresponding to the at least one visual feature 906, the UE 902 may estimate its position or using such information to assist the convergence of its positioning engine (e.g., by reducing the search space for its RTK/PPP module(s) and/or IAR process). The reception of the list of visual features may be performed by, e.g., the vision-aided positioning component 198, the camera 1632, the one or more sensors 1618, the transceiver(s) 1622, the cellular baseband processor(s) 1624, and/or the application processor(s) 1606 of the apparatus 1604 in FIG. 16.

In one example, the UE may transmit, to the reference device, a request for the list of visual features prior to the reception of the list of visual features, such as described in connection with FIGS. 9 to 12. For example, as discussed in connection with 928 of FIG. 9, the UE 902 may transmit, to the reference system 904, a request for the list of visual features and their corresponding locations. In response, the reference system 904 may transmit the list of visual features and their corresponding locations to the UE 902 based on the request as shown at 920. The transmission of the request may be performed by, e.g., the vision-aided positioning component 198, the camera 1632, the one or more sensors 1618, the transceiver(s) 1622, the cellular baseband processor(s) 1624, and/or the application processor(s) 1606 of the apparatus 1604 in FIG. 16.

In another example, the UE may receive, from the reference device, a 6DOF of the reference device and real-time GNSS measurements, such as described in connection with FIGS. 9 to 12. For example, as discussed in connection with 930 of FIG. 9, the UE 902 may receive, from the reference system 904, the 6DOF information and/or satellite measurements (e.g., GNSS/GPS measurements) of the reference system 904 to further assist the UE 902 with the positioning. The reception of the 6DOF of the reference device and real-time GNSS measurements may be performed by, e.g., the vision-aided positioning component 198, the camera 1632, the one or more sensors 1618, the transceiver(s) 1622, the cellular baseband processor(s) 1624, and/or the application processor(s) 1606 of the apparatus 1604 in FIG. 16. In some implementations, the reference device may include a GNSS module, at least one IMU, and one or more cameras, and where a 6DOF of the reference device is converged. In some implementations, to estimate the position of the UE based on the identified at least one visual feature in the area and the location corresponding to the at least one visual feature, the UE may initiate a 6DOF estimation process for a positioning engine based on the location corresponding to the at least one visual feature, the 6DOF of the reference device, and the real-time GNSS measurements, and the UE may calculate the position of the UE after the positioning engine converges. In some implementations, to receive the list of visual features, the location for each visual feature in the list of visual features, the 6DOF of the reference device, and the real-time GNSS measurements, the UE may receive, via a broadcast message or a unicast message, the list of visual features, the location for each visual feature in the list of visual features, the 6DOF of the reference device, and the real-time GNSS measurements.

In another example, the UE may output an indication of the estimated position of the UE, such as described in connection with FIGS. 9 to 12. For example, as discussed in connection with 926 of FIG. 9, depending on the implementations, the UE 902 may output its estimated position (e.g., to another entity or application) or store the estimated position in a memory. The outputting of the indication may be performed by, e.g., the vision-aided positioning component 198, the camera 1632, the one or more sensors 1618, the transceiver(s) 1622, the cellular baseband processor(s) 1624, and/or the application processor(s) 1606 of the apparatus 1604 in FIG. 16. In some implementations, to output the indication of the estimated position of the UE, the UE may transmit the indication of the estimated position of the UE, or store the indication of the estimated position of the UE.

In another example, the position of the UE may be at least one of: a relative position of the UE, a past position of the UE, a current position of the UE, or an estimated future position of the UE.

In another example, each visual feature in the list of visual features may correspond to an object in an environment, a part of the object, or a characteristic of the object.

In another example, to estimate the position of the UE, the UE may estimate the position of the UE based on VAPP.

In another example, the location corresponding to the at least one visual feature may be a function of a 6DOF of the at least one camera.

In another example, the list of visual features may include a set of artificial features, and where the at least one visual feature may include at least one artificial feature in the set of artificial features. In some implementations, the set of artificial features may correspond to a set of light projections.

In another example, the server may be a local map database, a map server, or an environment server, and where the list of visual features may be based on visual features presented in the map from the local map database, the map server, or the environment server.

In another example, the UE may obtain (e.g., from the local map database, the map server, or the environment server) trajectory information of a set of vehicles, and to estimate the position of the UE, the UE may estimate the position of the UE further based on the trajectory information.

In another example, the UE may obtain (e.g., from the local map database, the map server, or the environment server) information associated with GNSS measurement error budgets, and to estimate the position of the UE, the UE may estimate the position of the UE further based on the information associated with the GNSS measurement error budgets.

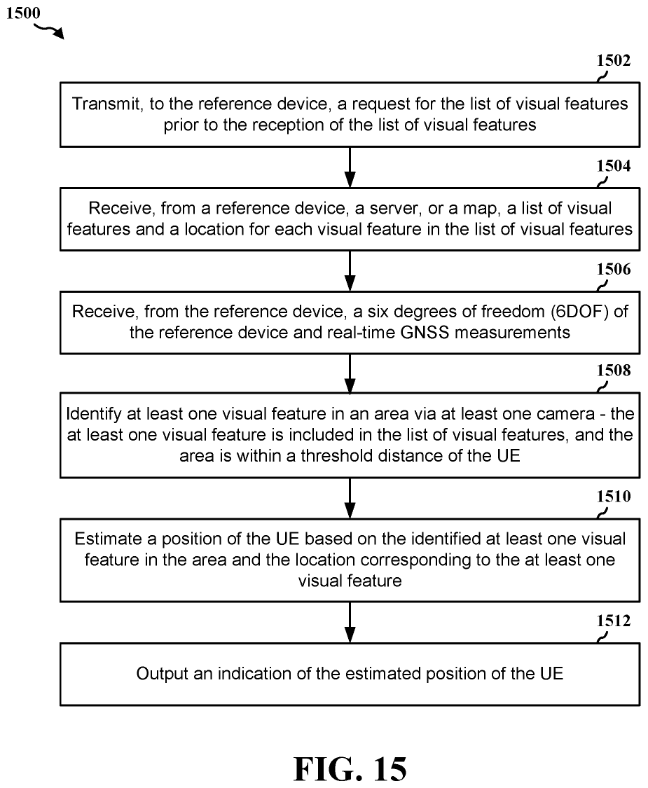

FIG. 15 is a flowchart 1500 of a method of wireless communication. The method may be performed by a UE (e.g., the UE 104, 404, 902, 1102; the GNSS device 506; the rover device 604; the vehicle 702; the apparatus 1604). The method may enable the UE to improve (e.g., reduce) the convergence time for vision-aided positioning by enabling the UE to use images embedded with location information.

At 1504, the UE may receive, from a reference device, a server, or a map, a list of visual features and a location for each visual feature in the list of visual features, such as described in connection with FIGS. 9 to 12. For example, as discussed in connection with 920 of FIG. 9, the UE 902 may receive, from the reference system 904 (or via a server), a list of visual features and their corresponding locations. The reception of the list of visual features may be performed by, e.g., the vision-aided positioning component 198, the camera 1632, the one or more sensors 1618, the transceiver(s) 1622, the cellular baseband processor(s) 1624, and/or the application processor(s) 1606 of the apparatus 1604 in FIG. 16.

At 1508, the UE may identify at least one visual feature in an area via at least one camera, where the at least one visual feature is included in the list of visual features, where the area is within a threshold distance of the UE, such as described in connection with FIGS. 9 to 12. For example, as discussed in connection with 922 of FIG. 9, based on the list of visual features and their corresponding locations received from the reference system 904 (or via the server), the UE 902 may be configured to identify at least one visual feature 906 (or a combination of visual features) in an area via its camera(s), where the at least one visual feature 906 (or the combination of visual features) is included in the list of visual features. The ident cation of the at least one visual feature may be performed by, e.g., the vision-aided positioning component 198, the camera 1632, the one or more sensors 1618, the transceiver(s) 1622, the cellular baseband processor(s) 1624, and/or the application processor(s) 1606 of the apparatus 1604 in FIG. 16.

At 1510, the UE may estimate a position of the UE based on the identified at least one visual feature in the area and the location corresponding to the at least one visual feature, such as described in connection with FIGS. 9 to 12. For example, as discussed in connection with 924 of FIG. 9, based on the at least one visual feature 906 and the location(s) corresponding to the at least one visual feature 906, the UE 902 may estimate its position or using such information to assist the convergence of its positioning engine (e.g., by reducing the search space for its RTK/PPP module(s) and/or IAR process). The reception of the list of visual features may be performed by, e.g., the vision-aided positioning component 198, the camera 1632, the one or more sensors 1618, the transceiver(s) 1622, the cellular baseband processor(s) 1624, and/or the application processor(s) 1606 of the apparatus 1604 in FIG. 16.

In one example, as shown at 1502, the UE may transmit, to the reference device, a request for the list of visual features prior to the reception of the list of visual features, such as described in connection with FIGS. 9 to 12. For example, as discussed in connection with 928 of FIG. 9, the UE 902 may transmit, to the reference system 904, a request for the list of visual features and their corresponding locations. In response, the reference system 904 may transmit the list of visual features and their corresponding locations to the UE 902 based on the request as shown at 920. The transmission of the request may be performed by, e.g., the vision-aided positioning component 198, the camera 1632, the one or more sensors 1618, the transceiver(s) 1622, the cellular baseband processor(s) 1624, and/or the application processor(s) 1606 of the apparatus 1604 in FIG. 16.

In another example, as shown at 1506, the UE may receive, from the reference device, a 6DOF of the reference device and real-time GNSS measurements, such as described in connection with FIGS. 9 to 12. For example, as discussed in connection with 930 of FIG. 9, the UE 902 may receive, from the reference system 904, the 6DOF information and/or satellite measurements (e.g., GNSS/GPS measurements) of the reference system 904 to further assist the UE 902 with the positioning. The reception of the 6DOF of the reference device and real-time GNSS measurements may be performed by, e.g., the vision-aided positioning component 198, the camera 1632, the one or more sensors 1618, the transceiver(s) 1622, the cellular baseband processor(s) 1624, and/or the application processor(s) 1606 of the apparatus 1604 in FIG. 16. In some implementations, the reference device may include a GNSS module, at least one IMU, and one or more cameras, and where a 6DOF of the reference device is converged. In some implementations, to estimate the position of the UE based on the identified at least one visual feature in the area and the location corresponding to the at least one visual feature, the UE may initiate a 6DOF estimation process for a positioning engine based on the location corresponding to the at least one visual feature, the 6DOF of the reference device, and the real-time GNSS measurements, and the UE may calculate the position of the UE after the positioning engine converges. In some implementations, to receive the list of visual features, the location for each visual feature in the list of visual features, the 6DOF of the reference device, and the real-time GNSS measurements, the UE may receive, via a broadcast message or a unicast message, the list of visual features, the location for each visual feature in the list of visual features, the 6DOF of the reference device, and the real-time GNSS measurements.

In another example, as shown at 1512, the UE may output an indication of the estimated position of the UE, such as described in connection with FIGS. 9 to 12. For example, as discussed in connection with 926 of FIG. 9, depending on the implementations, the UE 902 may output its estimated position (e.g., to another entity or application) or store the estimated position in a memory. The outputting of the indication may be performed by, e.g., the vision-aided positioning component 198, the camera 1632, the one or more sensors 1618, the transceiver(s) 1622, the cellular baseband processor(s) 1624, and/or the application processor(s) 1606 of the apparatus 1604 in FIG. 16. In some implementations, to output the indication of the estimated position of the UE, the UE may transmit the indication of the estimated position of the UE, or store the indication of the estimated position of the UE.

In another example, the position of the UE may be at least one of: a relative position of the UE, a past position of the UE, a current position of the UE, or an estimated future position of the UE.

In another example, each visual feature in the list of visual features may correspond to an object in an environment, a part of the object, or a characteristic of the object.

In another example, to estimate the position of the UE, the UE may estimate the position of the UE based on VAPP.

In another example, the location corresponding to the at least one visual feature may be a function of a 6DOF of the at least one camera.

In another example, the list of visual features may include a set of artificial features, and where the at least one visual feature may include at least one artificial feature in the set of artificial features. In some implementations, the set of artificial features may correspond to a set of light projections.

In another example, the server may be a local map database, a map server, or an environment server, and where the list of visual features may be based on visual features presented in a map from the local map database, the map server, or the environment server.

In another example, the UE may obtain trajectory information of a set of vehicles, and to estimate the position of the UE, the UE may estimate the position of the UE further based on the trajectory information.

In another example, the UE may obtain information associated with GNSS measurement error budgets, and to estimate the position of the UE, the UE may estimate the position of the UE further based on the information associated with the GNSS measurement error budgets.

FIG. 16 is a diagram 1600 illustrating an example of a hardware implementation for an apparatus 1604. The apparatus 1604 may be a UE, a component of a UE, or may implement UE functionality. In some aspects, the apparatus 1604 may include at least one cellular baseband processor 1624 (also referred to as a modem) coupled to one or more transceivers 1622 (e.g., cellular RF transceiver). The cellular baseband processor(s) 1624 may include at least one on-chip memory 1624′. In some aspects, the apparatus 1604 may further include one or more subscriber identity modules (SIM) cards 1620 and at least one application processor 1606 coupled to a secure digital (SD) card 1608 and a screen 1610. The application processor(s) 1606 may include on-chip memory 1606′. In some aspects, the apparatus 1604 may further include a Bluetooth module 1612, a WLAN module 1614, an ultrawide band (UWB) module 1638, an in-cabin monitoring system (ICMS) 1640, an SPS module 1616 (e.g., GNSS module), one or more sensors 1618 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1626, a power supply 1630, and/or a camera 1632. The Bluetooth module 1612, the UWB module 1638, the ICMS 1640, the WLAN module 1614, and the SPS module 1616 may include an on-chip transceiver (TRX) (or in some cases, just a receiver (RX)). The Bluetooth module 1612, the WLAN module 1614, and the SPS module 1616 may include their own dedicated antennas and/or utilize the antennas 1680 for communication. The cellular baseband processor(s) 1624 communicates through the transceiver(s) 1622 via one or more antennas 1680 with the UE 104 and/or with an RU associated with a network entity 1602. The cellular baseband processor(s) 1624 and the application processor(s) 1606 may each include a computer-readable medium/memory 1624′, 1606′, respectively. The additional memory modules 1626 may also be considered a computer-readable medium/memory. Each computer-readable medium/memory 1624′, 1606′, 1626 may be non-transitory. The cellular baseband processor(s) 1624 and the application processor(s) 1606 are each responsible for general processing, including the execution of software stored on the computer-readable medium/memory. The software, when executed by the cellular baseband processor(s) 1624/application processor(s) 1606, causes the cellular baseband processor(s) 1624/application processor(s) 1606 to perform the various functions described supra. The cellular baseband processor(s) 1624 and the application processor(s) 1606 are configured to perform the various functions described supra based at least in part of the information stored in the memory. That is, the cellular baseband processor(s) 1624 and the application processor(s) 1606 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1624/application processor(s) 1606 when executing software. The cellular baseband processor(s) 1624/application processor(s) 1606 may be a component of the UE 350 and may include the at least one memory 360 and/or at least one of the TX processor 368, the RX processor 356, and the controller/processor 359. In one configuration, the apparatus 1604 may be at least one processor chip (modem and/or application) and include just the cellular baseband processor(s) 1624 and/or the application processor(s) 1606, and in another configuration, the apparatus 1604 may be the entire UE (e.g., see UE 350 of FIG. 3) and include the additional modules of the apparatus 1604.

As discussed supra, the vision-aided positioning component 198 may be configured to receive, from a reference device, a server, or a map, a list of visual features and a location for each visual feature in the list of visual features. The vision-aided positioning component 198 may also be configured to identify at least one visual feature in an area via at least one camera, where the at least one visual feature is included in the list of visual features, where the area is within a threshold distance of the UE. The vision-aided positioning component 198 may also be configured to estimate a position of the UE based on the identified at least one visual feature in the area and the location corresponding to the at least one visual feature. The vision-aided positioning component 198 may be within the cellular baseband processor(s) 1624, the application processor(s) 1606, or both the cellular baseband processor(s) 1624 and the application processor(s) 1606. The vision-aided positioning component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1604 may include a variety of components configured for various functions. In one configuration, the apparatus 1604, and in particular the cellular baseband processor(s) 1624 and/or the application processor(s) 1606, may include means for receiving, from a reference device, a server, or a map, a list of visual features and a location for each visual feature in the list of visual features. The apparatus 1604 may further include means for identifying at least one visual feature in an area via at least one camera, where the at least one visual feature is included in the list of visual features, where the area is within a threshold distance of the UE. The apparatus 1604 may further include means for estimating a position of the UE based on the identified at least one visual feature in the area and the location corresponding to the at least one visual feature.

In one configuration, the apparatus 1604 may further include means for transmitting, to the reference device, a request for the list of visual features prior to the reception of the list of visual features.

In another configuration, the apparatus 1604 may further include means for receiving, from the reference device, a 6DOF of the reference device and real-time GNSS measurements. In some implementations, the reference device may include a GNSS module, at least one IMU, and one or more cameras, and where a 6DOF of the reference device is converged. In some implementations, the means for estimating the position of the UE based on the identified at least one visual feature in the area and the location corresponding to the at least one visual feature may include configuring the apparatus 1604 to initiate a 6DOF estimation process for a positioning engine based on the location corresponding to the at least one visual feature, the 6DOF of the reference device, and the real-time GNSS measurements, and calculate the position of the UE after the positioning engine converges. In some implementations, the means for receiving the list of visual features, the location for each visual feature in the list of visual features, the 6DOF of the reference device, and the real-time GNSS measurements may include configuring the apparatus 1604 to receive, via a broadcast message or a unicast message, the list of visual features, the location for each visual feature in the list of visual features, the 6DOF of the reference device, and the real-time GNSS measurements.

In another configuration, the apparatus 1604 may further include means for outputting an indication of the estimated position of the UE. In some implementations, the means for outputting the indication of the estimated position of the UE may include configuring the apparatus 1604 to transmit the indication of the estimated position of the UE, or store the indication of the estimated position of the UE.

In another configuration, the position of the UE may be at least one of: a relative position of the UE, a past position of the UE, a current position of the UE, or an estimated future position of the UE.

In another configuration, each visual feature in the list of visual features may correspond to an object in an environment, a part of the object, or a characteristic of the object.

In another configuration, the means for estimating the position of the UE may include configuring the apparatus 1604 to estimate the position of the UE based on VAPP.

In another configuration, the location corresponding to the at least one visual feature may be a function of a 6DOF of the at least one camera.

In another configuration, the list of visual features may include a set of artificial features, and where the at least one visual feature may include at least one artificial feature in the set of artificial features. In some implementations, the set of artificial features may correspond to a set of light projections.

In another configuration, the server may be a local map database, a map server, or an environment server, and where the list of visual features may be based on visual features presented in the map from the map server or from the environment server. In some implementations, the apparatus 1604 may further include means for obtaining trajectory information of a set of vehicles, and the means for estimating the position of the UE may include configuring the apparatus 1604 to estimate the position of the UE further based on the trajectory information. In some implementations, the apparatus 1604 may further include means for obtaining information associated with GNSS measurement error budgets, and the means for estimating the position of the UE may include configuring the apparatus 1604 to estimate the position of the UE further based on the information associated with the GNSS measurement error budgets.

The means may be the vision-aided positioning component 198 of the apparatus 1604 configured to perform the functions recited by the means. As described supra, the apparatus 1604 may include the TX processor 368, the RX processor 356, and the controller/processor 359. As such, in one configuration, the means may be the TX processor 368, the RX processor 356, and/or the controller/processor 359 configured to perform the functions recited by the means.

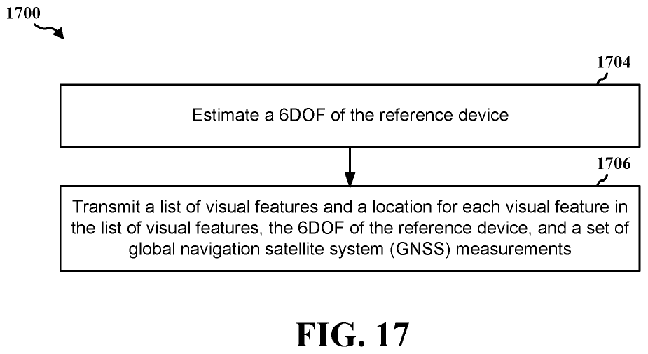

FIG. 17 is a flowchart 1700 of a method of wireless communication. The method may be performed by a reference device (e.g., the one or more location servers 168; the base station 102, 602; the reference system 904; the server 1104; the network entity 1960). The method may enable the reference device to provide reference information to a UE to assist the UE with vision-aided positioning.

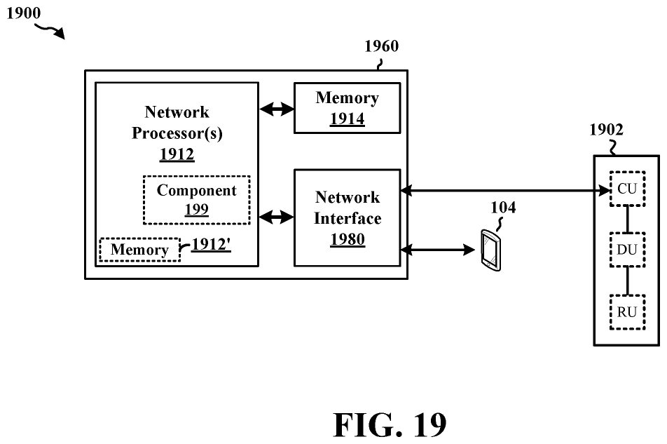

At 1704, the reference system may estimate a 6DOF of the reference device, such as described in connection with FIG. 9. For example, as discussed in connection with 930 of FIG. 9, the reference system 904 may also estimate its 6DOF and/or provide its 6DOF information and/or satellite measurements (e.g., GNSS/GPS measurements) to the UE 902 to further assist the UE 902 with the positioning. The estimation of the 6DOF may be performed by, e.g., the reference information generation component 199, the network processor(s) 1912, and/or the network interface 1980 of the network entity 1960 in FIG. 19.

At 1706, the reference system may transmit a list of visual features and a location for each visual feature in the list of visual features, the 6DOF of the reference device, and a set of GNSS measurements, such as described in connection with FIG. 9. For example, as discussed in connection with 920 of FIG. 9, the reference system 904 may transmit, to the UE 902, a list of visual features and their corresponding locations. As discussed in connection with 930 of FIG. 9, the reference system 904 may also provide its 6DOF information and/or satellite measurements (e.g., GNSS/GPS measurements) to the UE 902 to further assist the UE 902 with the positioning. The transmission of the list of visual features, the 6DOF of the reference device, and the set of GNSS measurements may be performed by, e.g., the reference information generation component 199, the network processor(s) 1912, and/or the network interface 1980 of the network entity 1960 in FIG. 19.

In one example, the reference system may receive, from a UE, a request for the list of visual features prior to the transmission of the list of visual features, such as described in connection with FIG. 9. For example, as discussed in connection with 928 of FIG. 9, the reference system 904 may receive, from the UE 902, a request for the list of visual features and their corresponding locations. The reception of the request may be performed by, e.g., the reference information generation component 199, the network processor(s) 1912, and/or the network interface 1980 of the network entity 1960 in FIG. 19. In some implementations, to transmit the list of visual features and the location for each visual feature in the list of visual features, the 6DOF of the reference device, and the set of GNSS measurements, the reference system may transmit, to the UE in response to the request, the list of visual features and the location for each visual feature in the list of visual features, the 6DOF of the reference device, and the set of GNSS measurements.

In another example, each visual feature in the list of visual features may correspond to an object in an environment, a part of the object, or a characteristic of the object.

In another example, the reference device may include a GNSS module, at least one IMU, and one or more cameras.

In another example, the 6DOF of the reference device may be converged prior to the transmission of the list of visual features and the location for each visual feature in the list of visual features, the 6DOF of the reference device, and the set of GNSS measurements.

In another example, to transmit the list of visual features and the location for each visual feature in the list of visual features, the 6DOF of the reference device, and the set of GNSS measurements, the reference device may transmit, via a broadcast message or a unicast message, the list of visual features and the location for each visual feature in the list of visual features, the 6DOF of the reference device, and the set of GNSS measurements.

In another example, the list of visual features may include a set of artificial features. In some implementations, the set of artificial features may correspond to a set of light projections. In some implementations, the reference device may project at least one visual feature in the list of visual features via a projection module, or cause at least one projection device to project the at least one visual feature.

In another example, the reference device may be associated with a local map database, a map server, or an environment server, and where the list of visual features may be based on visual features presented in the map from the map server or from the environment server.

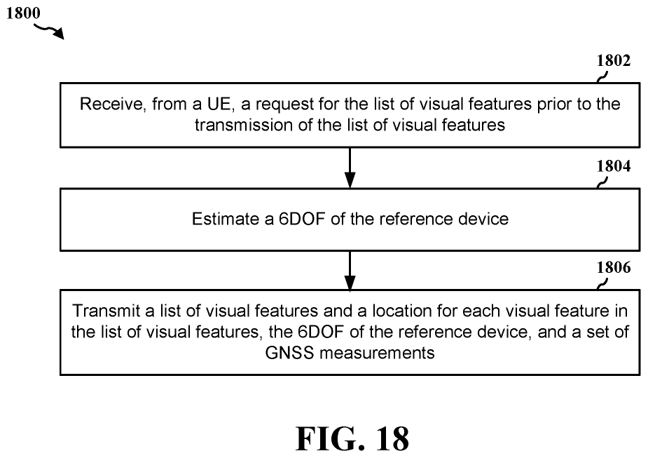

FIG. 18 is a flowchart 1800 of a method of wireless communication. The method may be performed by a reference device (e.g., the one or more location servers 168; the base station 102, 602; the reference system 904; the server 1104; the network entity 1960). The method may enable the reference device to provide reference information to a UE to assist the UE with vision-aided positioning.

At 1804, the reference system may estimate a 6DOF of the reference device, such as described in connection with FIG. 9. For example, as discussed in connection with 930 of FIG. 9, the reference system 904 may also estimate its 6DOF and/or provide its 6DOF information and/or satellite measurements (e.g., GNSS/GPS measurements) to the UE 902 to further assist the UE 902 with the positioning. The estimation of the 6DOF may be performed by, e.g., the reference information generation component 199, the network processor(s) 1912, and/or the network interface 1980 of the network entity 1960 in FIG. 19.

At 1806, the reference system may transmit a list of visual features and a location for each visual feature in the list of visual features, the 6DOF of the reference device, and a set of GNSS measurements, such as described in connection with FIG. 9. For example, as discussed in connection with 920 of FIG. 9, the reference system 904 may transmit, to the UE 902, a list of visual features and their corresponding locations. As discussed in connection with 930 of FIG. 9, the reference system 904 may also provide its 6DOF information and/or satellite measurements (e.g., GNSS/GPS measurements) to the UE 902 to further assist the UE 902 with the positioning. The transmission of the list of visual features, the 6DOF of the reference device, and the set of GNSS measurements may be performed by, e.g., the reference information generation component 199, the network processor(s) 1912, and/or the network interface 1980 of the network entity 1960 in FIG. 19.

In one example, as shown at 1802, the reference system may receive, from a UE, a request for the list of visual features prior to the transmission of the list of visual features, such as described in connection with FIG. 9. For example, as discussed in connection with 928 of FIG. 9, the reference system 904 may receive, from the UE 902, a request for the list of visual features and their corresponding locations. The reception of the request may be performed by, e.g., the reference information generation component 199, the network processor(s) 1912, and/or the network interface 1980 of the network entity 1960 in FIG. 19. In some implementations, to transmit the list of visual features and the location for each visual feature in the list of visual features, the 6DOF of the reference device, and the set of GNSS measurements, the reference system may transmit, to the UE in response to the request, the list of visual features and the location for each visual feature in the list of visual features, the 6DOF of the reference device, and the set of GNSS measurements.

In another example, each visual feature in the list of visual features may correspond to an object in an environment, a part of the object, or a characteristic of the object.

In another example, the reference device may include a GNSS module, at least one IMU, and one or more cameras.

In another example, the 6DOF of the reference device may be converged prior to the transmission of the list of visual features and the location for each visual feature in the list of visual features, the 6DOF of the reference device, and the set of GNSS measurements.

In another example, to transmit the list of visual features and the location for each visual feature in the list of visual features, the 6DOF of the reference device, and the set of GNSS measurements, the reference device may transmit, via a broadcast message or a unicast message, the list of visual features and the location for each visual feature in the list of visual features, the 6DOF of the reference device, and the set of GNSS measurements.

In another example, the list of visual features may include a set of artificial features. In some implementations, the set of artificial features may correspond to a set of light projections. In some implementations, the reference device may project at least one visual feature in the list of visual features via a projection module, or cause at least one projection device to project the at least one visual feature.

In another example, the reference device may be associated with a local map database, a map server, or an environment server, and where the list of visual features may be based on visual features presented in the map from the map server or from the environment server.

FIG. 19 is a diagram 1900 illustrating an example of a hardware implementation for a network entity 1960. In one example, the network entity 1960 may be within the core network 120. The network entity 1960 may include at least one network processor 1912. The network processor(s) 1912 may include on-chip memory 1912′. In some aspects, the network entity 1960 may further include additional memory modules 1914. The network entity 1960 communicates via the network interface 1980 directly (e.g., backhaul link) or indirectly (e.g., through a RIC) with the CU 1902. The on-chip memory 1912′ and the additional memory modules 1914 may each be considered a computer-readable medium/memory. Each computer-readable medium/memory may be non-transitory. The network processor(s) 1912 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the reference information generation component 199 may be configured to transmit, to a UE, a first indication of map data. The reference information generation component 199 may also be configured to estimate a 6DOF of the reference device. The reference information generation component 199 may also be configured to transmit a list of visual features and a location for each visual feature in the list of visual features, the 6DOF of the reference device, and a set of GNSS measurements. The reference information generation component 199 may be within the network processor(s) 1912. The reference information generation component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1960 may include a variety of components configured for various functions. In one configuration, the network entity 1960 may include means for estimating a 6DOF of the reference device. The network entity 1960 may further include means for transmitting a list of visual features and a location for each visual feature in the list of visual features, the 6DOF of the reference device, and a set of GNSS measurements.

In one configuration, the network entity 1960 may further include means for receiving, from a UE, a request for the list of visual features prior to the transmission of the list of visual features. In some implementations, the means for transmitting the list of visual features and the location for each visual feature in the list of visual features, the 6DOF of the reference device, and the set of GNSS measurements may include configuring the network entity 1960 to transmit, to the UE in response to the request, the list of visual features and the location for each visual feature in the list of visual features, the 6DOF of the reference device, and the set of GNSS measurements. In another configuration, each visual feature in the list of visual features may correspond to an object in an environment, a part of the object, or a characteristic of the object.

In another configuration, the reference device may include a GNSS module, at least one IMU, and one or more cameras.

In another configuration, the 6DOF of the reference device may be converged prior to the transmission of the list of visual features and the location for each visual feature in the list of visual features, the 6DOF of the reference device, and the set of GNSS measurements.

In another configuration, the means for transmitting the list of visual features and the location for each visual feature in the list of visual features, the 6DOF of the reference device, and the set of GNSS measurements may include configuring the network entity 1960 to transmit, via a broadcast message or a unicast message, the list of visual features and the location for each visual feature in the list of visual features, the 6DOF of the reference device, and the set of GNSS measurements.

In another configuration, the list of visual features may include a set of artificial features. In some implementations, the set of artificial features may correspond to a set of light projections. In some implementations, the network entity 1960 may further include means for projecting at least one visual feature in the list of visual features via a projection module, or means for causing at least one projection device to project the at least one visual feature.

In another configuration, the network entity 1960 may be associated with a local map database, a map server, or an environment server, and where the list of visual features may be based on visual features presented in the map from the map server or from the environment server.

The means may be the reference information generation component 199 of the network entity 1960 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a user equipment (UE), comprising: receiving, from a reference device, a server, or a map, a list of visual features and a location for each visual feature in the list of visual features; identifying at least one visual feature in an area via at least one camera, wherein the at least one visual feature is included in the list of visual features, wherein the area is within a threshold distance of the UE; and estimating a position of the UE based on the identified at least one visual feature in the area and the location corresponding to the at least one visual feature.

Aspect 2 is the method of aspect 1, further comprising: outputting an indication of the estimated position of the UE.

Aspect 3 is the method of aspect 1 or aspect 2, wherein outputting the indication of the estimated position of the UE comprises: transmitting the indication of the estimated position of the UE; or storing the indication of the estimated position of the UE.

Aspect 4 is the method of any of aspects 1 to 3, further comprising: transmitting, to the reference device, a request for the list of visual features prior to the reception of the list of visual features.

Aspect 5 is the method of any of aspects 1 to 4, wherein the position of the UE is at least one of: a relative position of the UE, a past position of the UE, a current position of the UE, or an estimated future position of the UE.

Aspect 6 is the method of any of aspects 1 to 5, wherein each visual feature in the list of visual features corresponds to an object in an environment, a part of the object, or a characteristic of the object.

Aspect 7 is the method of any of aspects 1 to 6, wherein the reference device includes a global navigation satellite system (GNSS) module, at least one inertial measurement unit (IMU), and one or more cameras, and wherein a six degrees of freedom (6DOF) of the reference device is converged.

Aspect 8 is the method of any of aspects 1 to 7, further comprising: receiving, from the reference device, the 6DOF of the reference device and real-time GNSS measurements.

Aspect 9 is the method of any of aspects 1 to 8, wherein estimating the position of the UE based on the identified at least one visual feature in the area and the location corresponding to the at least one visual feature comprises: initiating a 6DOF estimation process for a positioning engine based on the location corresponding to the at least one visual feature, the 6DOF of the reference device, and the real-time GNSS measurements; and calculating the position of the UE after the positioning engine converges.

Aspect 10 is the method of any of aspects 1 to 9, wherein receiving the list of visual features, the location for each visual feature in the list of visual features, the 6DOF of the reference device, and the real-time GNSS measurements comprises receiving, via a broadcast message or a unicast message, the list of visual features, the location for each visual feature in the list of visual features, the 6DOF of the reference device, and the real-time GNSS measurements.

Aspect 11 is the method of any of aspects 1 to 10, wherein estimating the position of the UE comprises estimating the position of the UE based on visual-aided precise positioning (VAPP).

Aspect 12 is the method of any of aspects 1 to 11, wherein the location corresponding to the at least one visual feature is a function of a six degrees of freedom (6DOF) of the at least one camera.

Aspect 13 is the method of any of aspects 1 to 12, wherein the list of visual features includes a set of artificial features, and wherein the at least one visual feature includes at least one artificial feature in the set of artificial features.

Aspect 14 is the method of any of aspects 1 to 13, wherein the set of artificial features corresponds to a set of laser projections.

Aspect 15 is the method of any of aspects 1 to 14, wherein the server is a map server, or an environment server, and wherein the list of visual features is based on visual features presented in the map from the map server or from the environment server.

Aspect 16 is the method of any of aspects 1 to 15, further comprising: obtaining trajectory information of a set of vehicles; and wherein estimating the position of the UE comprises estimating the position of the UE further based on the trajectory information.

Aspect 17 is the method of any of aspects 1 to 16, further comprising: obtaining information associated with global navigation satellite system (GNSS) measurement error budgets; and wherein estimating the position of the UE comprises estimating the position of the UE further based on the information associated with the GNSS measurement error budgets.

Aspect 18 is an apparatus for wireless communication at a user equipment (UE), including: at least one memory; and at least one processor coupled to the at least one memory and, based at least in part on information stored in the at least one memory, the at least one processor, individually or in any combination, is configured to implement any of aspects 1 to 17.

Aspect 19 is the apparatus of aspect 18, further including at least one of a transceiver or an antenna coupled to the at least one processor.

Aspect 20 is an apparatus for wireless communication including means for implementing any of aspects 1 to 17.

Aspect 21 is a computer-readable medium (e.g., a non-transitory computer-readable medium) storing computer executable code, where the code when executed by a processor causes the processor to implement any of aspects 1 to 17.

Aspect 22 is a method of wireless communication at a reference device, comprising: estimating a six degrees of freedom (6DOF) of the reference device; and transmitting a list of visual features and a location for each visual feature in the list of visual features, the 6DOF of the reference device, and a set of global navigation satellite system (GNSS) measurements.

Aspect 23 is the method of aspect 22, further comprising: receiving, from a user equipment (UE), a request for the list of visual features prior to the transmission of the list of visual features.

Aspect 24 is the method of aspect 22 or aspect 23, wherein transmitting the list of visual features and the location for each visual feature in the list of visual features, the 6DOF of the reference device, and the set of GNSS measurements comprises transmitting, to the UE in response to the request, the list of visual features and the location for each visual feature in the list of visual features, the 6DOF of the reference device, and the set of GNSS measurements.

Aspect 25 is the method of any of aspects 22 to 24, wherein each visual feature in the list of visual features corresponds to an object in an environment, a part of the object, or a characteristic of the object.

Aspect 26 is the method of any of aspects 22 to 25, wherein the reference device includes a global navigation satellite system (GNSS) module, at least one inertial measurement unit (IMU), and one or more cameras.

Aspect 27 is the method of any of aspects 22 to 26, wherein the 6DOF of the reference device is converged prior to the transmission of the list of visual features and the location for each visual feature in the list of visual features, the 6DOF of the reference device, and the set of GNSS measurements.

Aspect 28 is the method of any of aspects 22 to 27, wherein transmitting the list of visual features and the location for each visual feature in the list of visual features, the 6DOF of the reference device, and the set of GNSS measurements comprises: transmitting, via a broadcast message or a unicast message, the list of visual features and the location for each visual feature in the list of visual features, the 6DOF of the reference device, and the set of GNSS measurements.

Aspect 29 is the method of any of aspects 22 to 28, wherein the list of visual features includes a set of artificial features.

Aspect 30 is the method of any of aspects 22 to 29, wherein the set of artificial features corresponds to a set of light projections.

Aspect 31 is the method of any of aspects 22 to 30, further comprising: projecting at least one visual feature in the list of visual features via a projection module, or causing at least one projection device to project the at least one visual feature.

Aspect 32 is the method of any of aspects 22 to 31, wherein the reference device is associated with a local map database, a map server, or an environment server, and wherein the list of visual features is based on visual features presented in the map from the map server or from the environment server.

Aspect 33 is an apparatus for wireless communication at a reference device, including: at least one memory; and at least one processor coupled to the at least one memory and, based at least in part on information stored in the at least one memory, the at least one processor, individually or in any combination, is configured to implement any of aspects 22 to 32.

Aspect 34 is the apparatus of aspect 33, further including at least one of a transceiver or an antenna coupled to the at least one processor.

Aspect 35 is an apparatus for wireless communication including means for implementing any of aspects 22 to 32.

Aspect 36 is a computer-readable medium (e.g., a non-transitory computer-readable medium) storing computer executable code, where the code when executed by a processor causes the processor to implement any of aspects 22 to 32.

What is claimed is:

1. An apparatus for wireless communication at a user equipment (UE), comprising:
at least one memory;
at least one transceiver; and
at least one processor coupled to the at least one memory and the at least one transceiver, the at least one processor, individually or in any combination, is configured to:
receive, from a reference device, a server, or a map, a list of visual features and a location for each visual feature in the list of visual features;
identify at least one visual feature in an area via at least one camera, wherein the at least one visual feature is included in the list of visual features, wherein the area is within a threshold distance of the UE; and
estimate a position of the UE based on the identified at least one visual feature in the area and the location corresponding to the at least one visual feature.

2. The apparatus of claim 1, wherein the at least one processor, individually or in any combination, is further configured to:
output an indication of the estimated position of the UE.

3. The apparatus of claim 2, wherein to output the indication of the estimated position of the UE, the at least one processor, individually or in any combination, is configured to:
transmit, via the at least one transceiver, the indication of the estimated position of the UE; or
store the indication of the estimated position of the UE.

4. The apparatus of claim 1, wherein the at least one processor, individually or in any combination, is further configured to:
transmit, to the reference device, a request for the list of visual features prior to the reception of the list of visual features.

5. The apparatus of claim 1, wherein the position of the UE is at least one of:
a relative position of the UE,
a past position of the UE,
a current position of the UE, or
an estimated future position of the UE.

6. The apparatus of claim 1, wherein each visual feature in the list of visual features corresponds to an object in an environment, a part of the object, or a characteristic of the object.

7. The apparatus of claim 1, wherein the reference device includes a global navigation satellite system (GNSS) module, at least one inertial measurement unit (IMU), and one or more cameras, and wherein a six degrees of freedom (6DOF) of the reference device is converged.

8. The apparatus of claim 7, wherein the at least one processor, individually or in any combination, is further configured to:
receive, from the reference device via the at least one transceiver, the 6DOF of the reference device and real-time GNSS measurements.

9. The apparatus of claim 8, wherein to estimate the position of the UE based on the identified at least one visual feature in the area and the location corresponding to the at least one visual feature, the at least one processor, individually or in any combination, is configured to:
initiate a 6DOF estimation process for a positioning engine based on the location corresponding to the at least one visual feature, the 6DOF of the reference device, and the real-time GNSS measurements; and
calculate the position of the UE after the positioning engine converges.

10. The apparatus of claim 8, wherein to receive the list of visual features, the location for each visual feature in the list of visual features, the 6DOF of the reference device, and the real-time GNSS measurements, the at least one processor, individually or in any combination, is configured to receive, via a broadcast message or a unicast message, the list of visual features, the location for each visual feature in the list of visual features, the 6DOF of the reference device, and the real-time GNSS measurements.

11. The apparatus of claim 1, wherein to estimate the position of the UE, the at least one processor, individually or in any combination, is configured to estimate the position of the UE based on visual-aided precise positioning (VAPP).

12. The apparatus of claim 1, wherein the location corresponding to the at least one visual feature is a function of a six degrees of freedom (6DOF) of the at least one camera.

13. The apparatus of claim 1, wherein the list of visual features includes a set of artificial features, and wherein the at least one visual feature includes at least one artificial feature in the set of artificial features.

14. The apparatus of claim 13, wherein the set of artificial features corresponds to a set of laser projections.

15. The apparatus of claim 1, wherein the server is a map server or an environment server, and wherein the list of visual features is based on visual features presented in the map from the map server or from the environment server.

16. The apparatus of claim 1, wherein the at least one processor, individually or in any combination, is further configured to:
obtain trajectory information of a set of vehicles; and
wherein to estimate the position of the UE, the at least one processor, individually or in any combination, is configured to estimate the position of the UE further based on the trajectory information.

17. The apparatus of claim 1, wherein the at least one processor, individually or in any combination, is further configured to:
obtain information associated with global navigation satellite system (GNSS) measurement error budgets; and
wherein to estimate the position of the UE, the at least one processor, individually or in any combination, is configured to estimate the position of the UE further based on the information associated with the GNSS measurement error budgets.

18. A method of wireless communication at a user equipment (UE), comprising:
receiving, from a reference device, a server, or a map, a list of visual features and a location for each visual feature in the list of visual features;
identifying at least one visual feature in an area via at least one camera, wherein the at least one visual feature is included in the list of visual features, wherein the area is within a threshold distance of the UE; and
estimating a position of the UE based on the identified at least one visual feature in the area and the location corresponding to the at least one visual feature.

19. An apparatus for wireless communication at a reference device, comprising:
at least one memory;
at least one transceiver; and
at least one processor coupled to the at least one memory and the at least one transceiver, the at least one processor, individually or in any combination, is configured to:
estimate a six degrees of freedom (6DOF) of the reference device; and
transmit, via the at least one transceiver, a list of visual features and a location for each visual feature in the list of visual features, the 6DOF of the reference device, and a set of global navigation satellite system (GNSS) measurements.

20. The apparatus of claim 19, wherein the at least one processor, individually or in any combination, is further configured to:
receive, from a user equipment (UE), a request for the list of visual features prior to the transmission of the list of visual features.

21. The apparatus of claim 20, wherein to transmit the list of visual features and the location for each visual feature in the list of visual features, the 6DOF of the reference device, and the set of GNSS measurements, the at least one processor, individually or in any combination, is configured to transmit, to the UE in response to the request, the list of visual features and the location for each visual feature in the list of visual features, the 6DOF of the reference device, and the set of GNSS measurements.

22. The apparatus of claim 19, wherein each visual feature in the list of visual features corresponds to an object in an environment, a part of the object, or a characteristic of the object.

23. The apparatus of claim 19, wherein the reference device includes a global navigation satellite system (GNSS) module, at least one inertial measurement unit (IMU), and one or more cameras.

24. The apparatus of claim 19, wherein the 6DOF of the reference device is converged prior to the transmission of the list of visual features and the location for each visual feature in the list of visual features, the 6DOF of the reference device, and the set of GNSS measurements.

25. The apparatus of claim 19, wherein to transmit the list of visual features and the location for each visual feature in the list of visual features, the 6DOF of the reference device, and the set of GNSS measurements, the at least one processor, individually or in any combination, is configured to:
transmit, via a broadcast message or a unicast message, the list of visual features and the location for each visual feature in the list of visual features, the 6DOF of the reference device, and the set of GNSS measurements.

26. The apparatus of claim 19, wherein the list of visual features includes a set of artificial features.

27. The apparatus of claim 26, wherein the set of artificial features corresponds to a set of light projections.

28. The apparatus of claim 26, wherein the at least one processor, individually or in any combination, is further configured to:
project at least one visual feature in the list of visual features via a projection module, or cause at least one projection device to project the at least one visual feature.

29. The apparatus of claim 19, wherein the reference device is associated with a map server or an environment server, and wherein the list of visual features is based on visual features presented in a map from the map server or from the environment server.

30. A method of wireless communication at a reference device, comprising:
estimating a six degrees of freedom (6DOF) of the reference device; and
transmitting a list of visual features and a location for each visual feature in the list of visual features, the 6DOF of the reference device, and a set of global navigation satellite system (GNSS) measurements.
